(19) United States
(12) Patent Application Publication
(10) Pub. No.: US 2005/0121504 A1
(43) Pub. Date: Jun. 9, 2005

(54) System and method for mobile entry of fitness program information

(76) Inventors: Gregory L. Sanders, Olathe, KS (US); Christopher J. Marsey, Idaho Falls, ID (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/459,255

(22) Filed: Jun. 11, 2003

Related U.S. Application Data
(60) Provisional application No. 60/387,821, filed on Jun. 11, 2002.

(51) Int. Cl. G06C 3/00

(52) U.S. Cl. 235/87 A

(57) ABSTRACT

A system for monitoring fitness and diet programs on a portable handheld device includes a graphical user interface device, and a bar code reader for electronically coupling with the graphical user interface device. The graphical user interface device includes a processor programmed to: receive data corresponding to at least one bar code as read by the bar code reader; and provide data corresponding to a graphical user interface for display on the graphical user interface device for monitoring at least one of diet, exercise or weight training, in accordance with the at least one bar code read by the bar code reader.

### CROSS-REFERENCES TO RELATED APPLICATIONS

This application claims priority from and is related to U.S. Provisional Patent Application Ser. No. 60/387,821, filed on Jun. 11, 2002, entitled: SYSTEM AND METHOD FOR MOBILE ENTRY OF FITNESS PROGRAM INFORMATION, this provisional patent application incorporated by reference in its entirety herein.

### TECHNICAL FIELD

The present invention is directed to personal fitness and diet programs therefor. In particular, The present invention is directed to a system of portable, handheld devices used by individuals at any of a variety of locations to conduct electronic management of his or her personal fitness and diet program.

### BACKGROUND

Personal fitness and diet programs requires constant attention to all aspects of a person's life. To maintain personal fitness and diet, one must be aware of what they are eating, what kind of physical exercise they are getting, when and how much they are sleeping, etc. Typical personal fitness and diet routines now focus on all of these, as well as other, aspects of life. Accordingly, it is necessary for the user to record and track all aspects of their daily life, in order to maximize their state of fitness.

Keeping records of ones daily activities toward personal fitness and diet is time consuming. It typically involves keeping paper logs that are messy, and can be voluminous. Also, simply keeping these records is time consuming, and requires one to keep writing equipment and paper everywhere they go. Moreover, even if this material is entered into a computer or other computer-type device, such as a personal digital assistant (PDA) or the like, entry is time consuming, and organizing it into a understandable and coordinated manner takes large amounts of time.

### SUMMARY OF THE INVENTION

The present invention is directed to a system of portable, handheld devices used by individuals at any of a variety of locations, including use in a home, grocery store, or gym, that may be used by the individual to conduct electronic management of his or her personal fitness and diet programs, to input workout and food consumption data, and to receive reporting and status information regarding his or her fitness program goals. The invention is also directed to the specific methods of using the system to scan barcodes on food products and fitness equipment, and using the system to expedite data entry into a user's fitness and diet program log. Although the detailed description refers specifically to the fitness industry, it should be understood that the system could be tailored to other industries, wherein the user-specific information would be specific to the industry, as would the nature of the information scanned, stored, and reported. In particular, the system can be used to scan an unknown barcode and enter data into a database. Using the barcode method accelerates data entry. The data is related to the object on which the barcode is placed.

A preferred configuration of the basic components of the fitness system of the present invention includes a handheld user interface device with an integrated, or attached, barcode reader. Preferably, the handheld device is programmed to run a PalmOS program, although other operating programs may be used consistent with the present invention. The handheld device can be interfaced with a computer. The handheld device will be programmed to offer the storage and reporting of fitness and diet program information for an individual. The fitness and diet program information will preferably contain weight and cardiovascular workout logs, food consumption or meal logs, a configurable database of weight and cardiovascular workout programs, a configurable database of food items, and storage of goals, such as daily calorie, fat, and carbohydrate consumptions, target heart rates, and desired body weight. The fitness and diet program information may contain other information pertinent to the fitness industry, or an individual's personalized fitness and diet program.

Preferably, the handheld device will have an integrated barcode reader. Any external barcode reader can be connected to the handheld device. The barcode reader will be used to accelerate data entry of information into the fitness and diet program information.

In a preferred method of utilizing the system, the handheld device archives fitness and diet program information onto a separate or long-term storage medium. Typically, the handheld device would be capable of syncing or transferring its information to a personal computer, or through web-based applications, through conventional HotSync or wireless technologies.

Another embodiment of the invention is directed to a system for monitoring fitness and diet programs on a portable handheld device. This system includes a graphical user interface device, and a bar code reader for electronically coupling with the graphical user interface device. The graphical user interface device includes a processor programmed to: receive data, typically non-inventory data, corresponding to at least one bar code as read by the bar code reader; and provide data corresponding to a graphical user interface for display on the graphical user interface device for monitoring at least one of diet, exercise or weight training, in accordance with the at least one bar code read by the bar code reader.

Another embodiment is directed to a method for recording and storing custom and dietary fitness information on a graphical user interface device, equipped with a barcode reader to expedite the user's entry of custom and general information. The method includes providing an interactive graphical display, which includes fitness categories, which are interactively selectable by a user on the graphical display surface, wherein fitness categories that are selectable include weights, cardiovascular, diet, history, goals, and summary, generated barcodes can be scanned so that information related thereto may be added, and selecting a category and entering or retrieving fitness data.

Another embodiment is directed to a method for monitoring fitness and diet information. This method includes, obtaining data, typically non-inventory data, associated with one of an item or an apparatus, typically from a data source; selecting at least one item or apparatus by scanning a bar code associated therewith; providing a graphical user interface corresponding to the at least one item or apparatus; receiving input provided to the graphical user interface; and adding the input to at least one data file for either of the fitness or the diet information. Obtaining data typically includes accessing data in a database corresponding to at least one an item or an apparatus, and can also include obtaining a barcode for the at least one item or an apparatus. The data source can be, for example, a database, a server, a storage device, such as a compact disc or the like, or any other source of electronic or magnetic storage.

### BRIEF DESCRIPTION OF DRAWINGS

Attention is now directed to the drawing figures where like numerals or characters indicate or corresponding or like components. In the drawings.

FIG. 1 is the initial user screen on the user interface device, which allows the user to tap the fitness or fitness plus option;

FIG. 2 is the fitness menu screen, which includes weight lifting, cardiovascular, exercise, diet, history, goal, and summary options that can be tapped by the user;

FIG. 3 is the weight menu screen, which includes icons for selecting muscle or exercise groups;

FIG. 4 is an example of a specific weight lifting exercise screen, which includes information related to repetitions, weight, and settings on a weight lifting device;

FIG. 5 is a weight lifting date screen for selecting a workout date, whereby tapping a date will take the user to a screen related to a pre-selected workout set for that day;

FIG. 6 is weight lifting edit screen for changing the particulars of a certain exercise;

FIG. 7 is a weight lifting note screen for recording information related to a particular weight lifting exercise;

FIG. 8 is a screen for sorting weight lifting exercises according to particular categories, which allows a user to tap on an option for sorting a weight program according to exercise name, muscle group, or equipment;

FIG. 9 is a screen allowing a user to add a new weight lifting exercise to a routine;

FIG. 10 is a screen related to a notation function, which allows the user to keep notes related to various exercises;

FIG. 11 is the cardiovascular menu screen, which includes icons for selecting cardiovascular activities or equipment;

FIG. 12 is a cardiovascular activity screen for sorting cardiovascular activities according to exercise name or equipment;

FIG. 13 is a cardiovascular activity screen for adding an activity to a cardiovascular workout;

FIG. 14 is notation screen for recording information related to a particular cardiovascular exercise;

FIG. 15 is a cardiovascular report screen for recording time, calories burned, and other information related to a cardiovascular exercise, whereby the user can tap the note icon to add a note related to that particular date and exercise;

FIG. 16 is a cardiovascular date screen for selecting a workout date, whereby tapping a date will take the user to a screen related to workouts recorded for that day or to enter new workout information for that date;

FIG. 17 is a cardiovascular screen for recording notes on a particular exercise;

FIG. 18 is a cardiovascular edit screen for changing the particulars of a certain cardiovascular exercise;

FIG. 19a is the diet menu screen, which allows the user to total caloric content of food items and to set a menu for a day;

FIG. 19b is the screen of FIG. 19a in an exemplary operation of an embodiment of the invention;

FIG. 20 is diet date screen for selecting a date, whereby tapping a date will take the user to a screen related to meal consumption recorded for that day;

FIG. 21 is a meal entry form screen for adding data related to a particular food or meal;

FIG. 22 is an edit screen for adding the particulars of a selected meal, including calories, fat, cholesterol, etc.;

FIG. 23 is the same as FIG. 22, except exemplary information is included;

FIG. 24 relates to a dietary goal screen which alerts the user as to whether he or she has met prescribed daily nutritional goals;

FIG. 25 is a dietary menu screen related to various meal options and recipes;

FIG. 26 is a dietary screen for sorting food items according to name, classification, or type;

FIG. 27 is a screen whereby new food items may be added to the database;

FIG. 28a is the same as FIG. 27, except exemplary information (non-inventory data) is included;

FIG. 28b is the same as FIG. 28a, except for a different food item;

FIG. 29 is a recipe screen for a particular food item with optional recipes available;

FIG. 30 has three dietary screens related to date information, meal number, and portions;

FIG. 31 relates to a screen for particular individual which allows for data to be entered related to that individual's particular health statistics, including age, weight, body fat, heart rate, etc., whereby this function can be used by a health professional and optionally to compute daily caloric changes needed to meet a specific weight goal;

FIG. 32 is a goal screen related to a particular individual in terms of weight loss and daily intake;

FIG. 33 is a summary screen for a particular date related to calories consumed and burned;

FIG. 34 relates to the fitness barcode user interface screen, which includes the fitness menu screen;

FIG. 35 is an illustration of the barcode user interface device, and a barcode;

FIG. 36 is a barcode and user interface related to a particular exercise;

FIG. 37 is a barcode and user interface related to a particular food item;

FIG. 38 is a screen with various palm options, including a fitness plus option, whereby the fitness plus option can be tapped by a trainer for use in setting up a fitness program;

FIG. 39 is a fitness plus main menu form, which includes client name and options for adding new clients to the form;

FIG. 40 includes two screens related to information for a personal trainer to enter information related to customers;

FIG. 41 is a screen for adding a new client to a particular trainer's menu;

FIG. 42 is a screen, which includes the fitness menu for entering data related to an individual client;

FIG. 43 is a screen for a client sign-in form for use with billing and payroll functions and for use by a fitness trainer;

FIG. 44 is a screen for a client sign-out form for a personal trainer an in-network option is provided for determining if the workout was at a network facility or elsewhere;

FIG. 45 is a diagram of an exemplary system in accordance with the present invention;

FIG. 46 is an alternate embodiment of an exemplary system in accordance with the present invention; and

FIG. 47 is a flow diagram of a process in accordance with the present invention.

### DETAILED DESCRIPTION OF DRAWINGS

The present invention relates to a method and system related to the use of a handheld graphical user interface, in handheld devices, such as Personal Digital Assistants (PDAs), for example, a Palm Pilot® or Palm PC®, with a Windows®, PalmOS™ or similar operating systems, cellular telephones and the like. These hand-held devices typically include processors (for example, microprocessors) that can be programmed for executing instructions, scripts and the like, and, here, for example, can be programmed for use in administering a personal fitness and diet program.

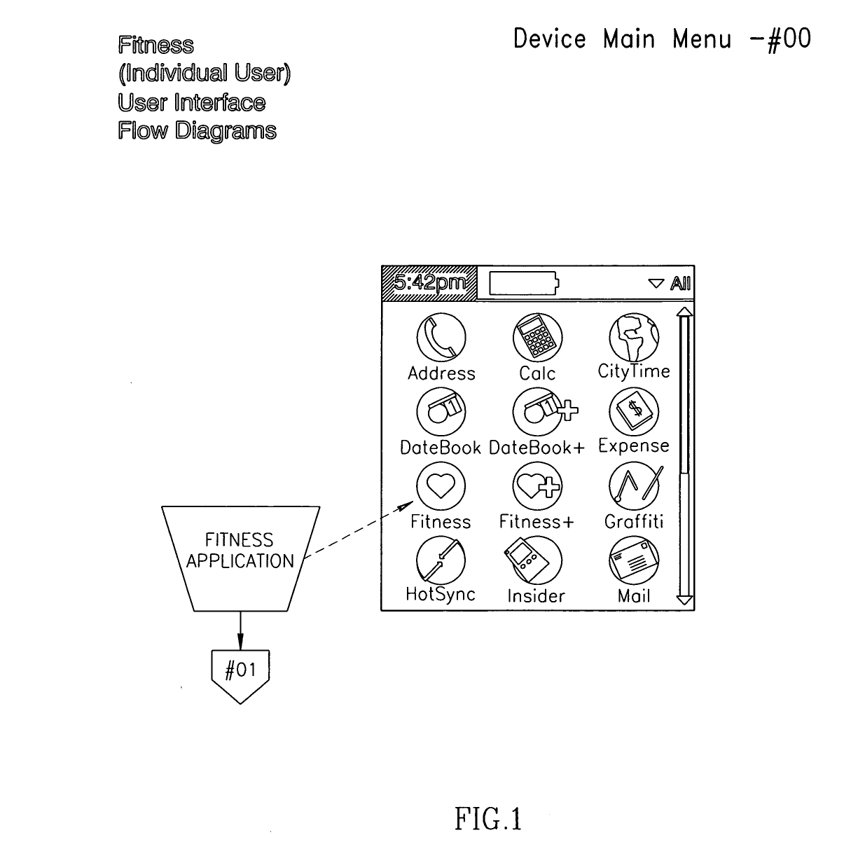

The interface device (handheld graphical user interface, user interface, graphical user interface device or handheld device, these terms used interchangeably hereinafter) will include a graphical user interface (GUI) for the overall device (FIG. 1), as well as GUIs that allow for a user to select various fitness and diet options to allow for the tracking of the user's workouts and diet. As such, the graphical interface user device allows for the user to retrieve stored data and to guide the user during a workout, or when dining. The system can include a support component, which is a personal computer (PC), workstation or other computer-type device, allowing the user to read and write data from the computer to the user interface. This is typically through a PC or web-based application.

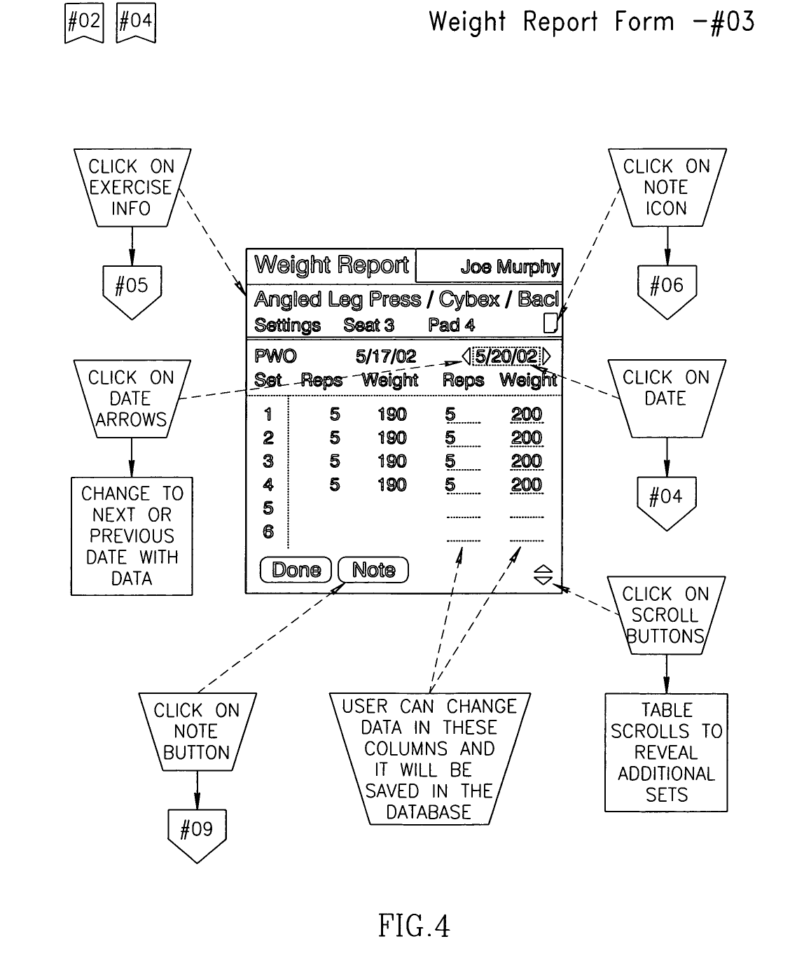

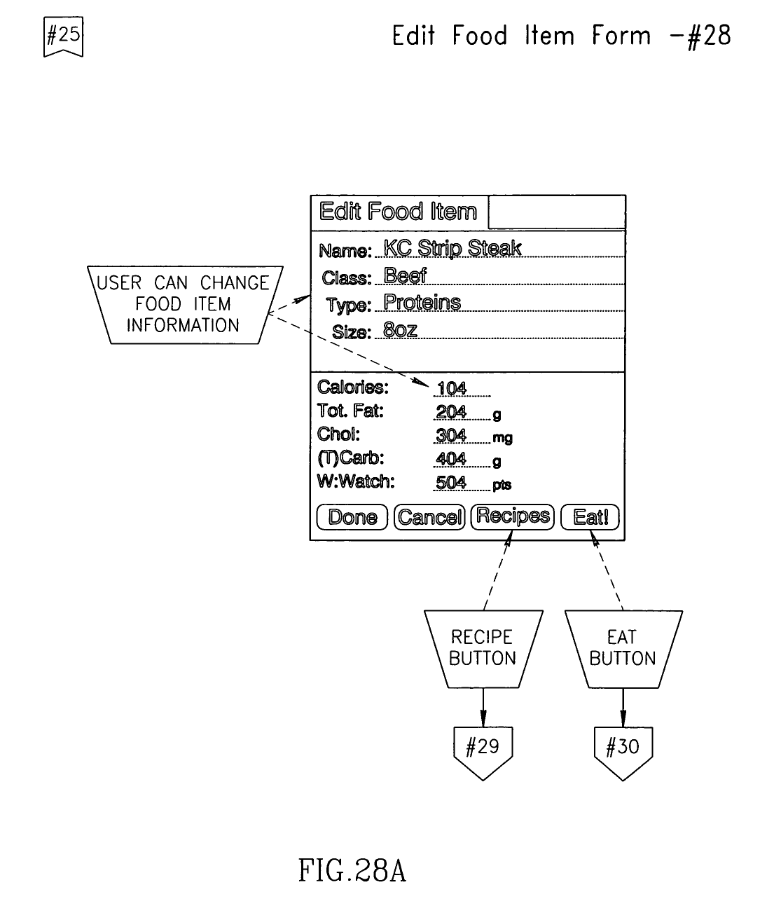

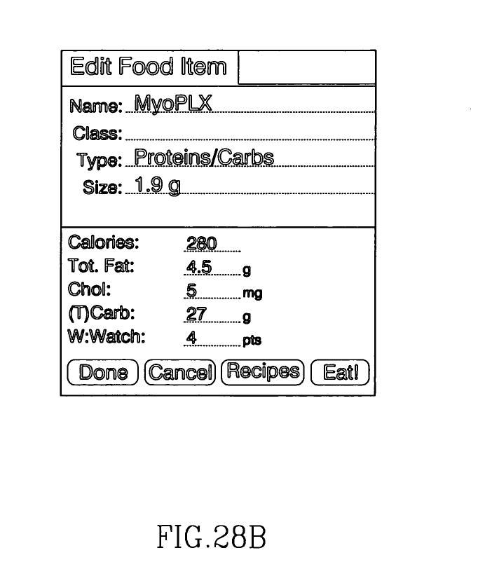

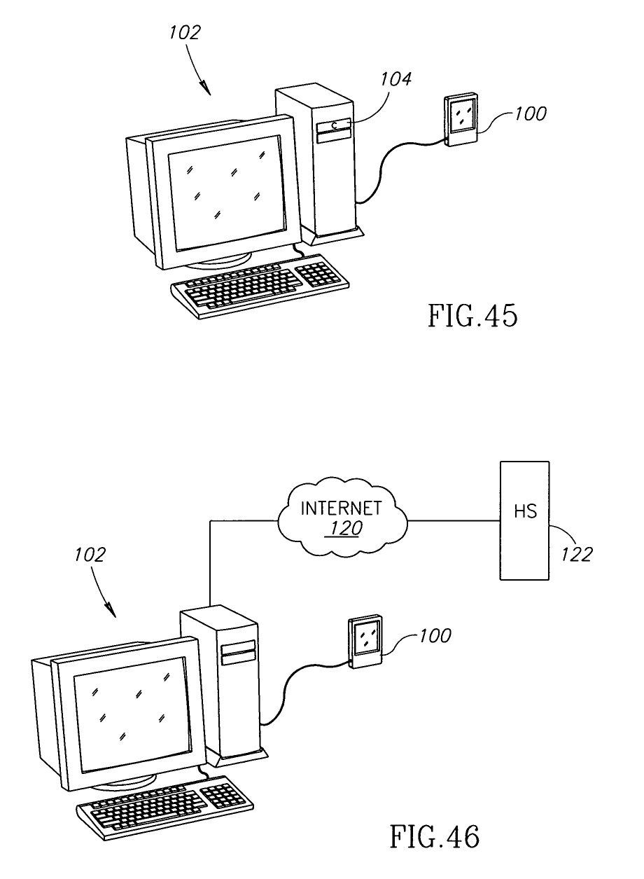

The read/written data is typically non-inventory data, from databases, storage devices and media, that include such non-inventory data corresponding to bar codes for items, machines, etc., as well as data for items, that is selected without a bar code. For example, non-inventory data for a food item, may include, calories, total fat, cholesterol, total carbohydrates, and Weight Watchers® points, as shown in FIGS. 28a and 28b. This non-inventory data is data that when the bar code is scanned, is different from merely listing the item and a quantity thereof. This non-inventory data is data placed into the database by the database creator, storage device maker, or storage device/server owner, for particular items, machines, etc. It is transferred to the user, into his handheld device, when requested, typically when the handheld device is linked to the computer, as shown in FIGS. 45 and 46 and described below. This non-inventory data can also be transferred to the handheld device, with programs, scripts, applets, etc, that will automatically call up the requisite screen or GUI on the handheld device, when the item, machine, etc. is selected, either by scanning a bar code, or manually, as detailed below. For example, as detailed below, should a Myoplex® bar be scanned, a screen of FIG. 28b will be called up, and will appear as a GUI on the handheld device. Similarly, should a Cybex® angled leg press machine, have its bar code scanned or manually entered, a screen like that of FIG. 4 will be called up and will appear as a GUI on the handheld device.

A bar code reader typically interfaces with and is electronically coupled to the handheld device. The bar code reader can be a part of the handheld device (as a single unit) or it can be a separate unit, attachable to the handheld device. However, the user interface device does not require a bar code reader if data can be entered manually therein. Exercise equipment and food packaging, for example, can be barcoded and read using a handheld user interface device. The barcode reader interfaced with the user interface will be used to retrieve and enter information. The system is also designed for use by a fitness professional.

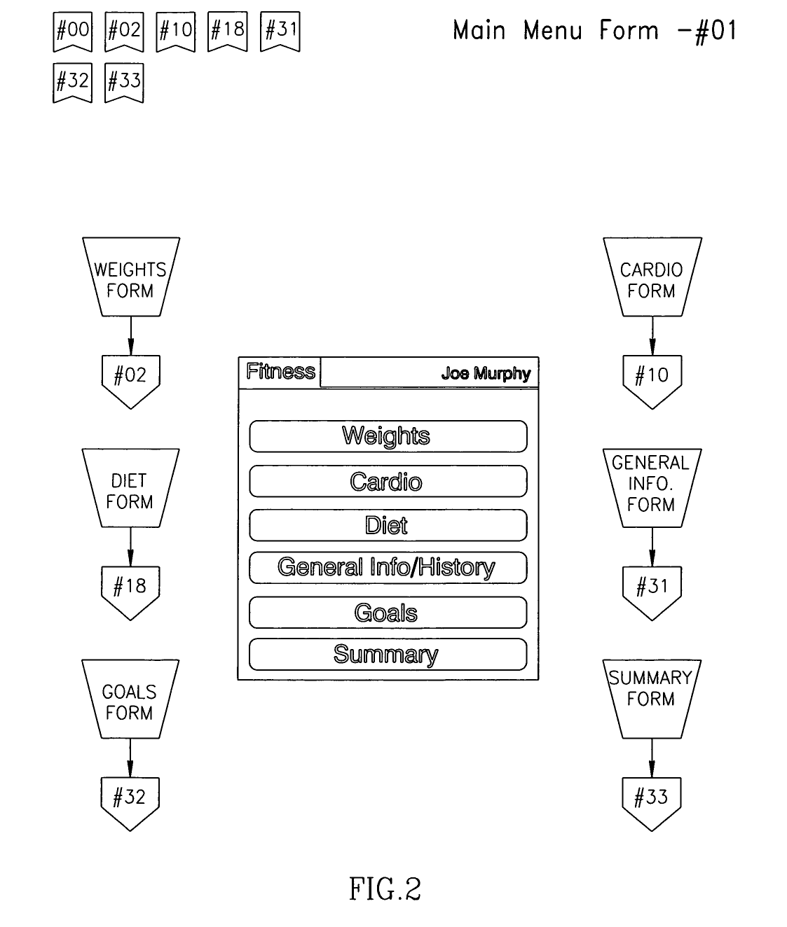

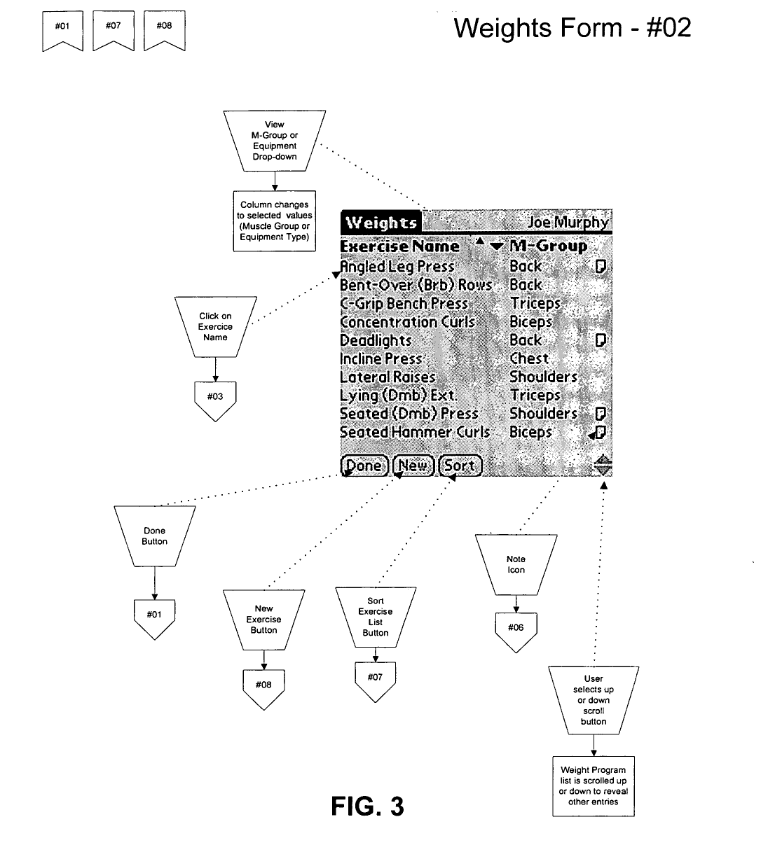

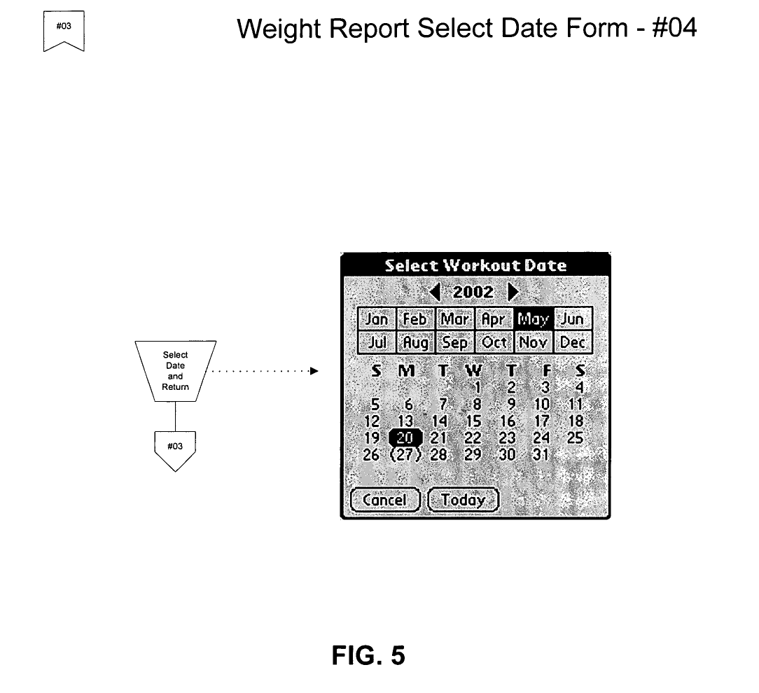

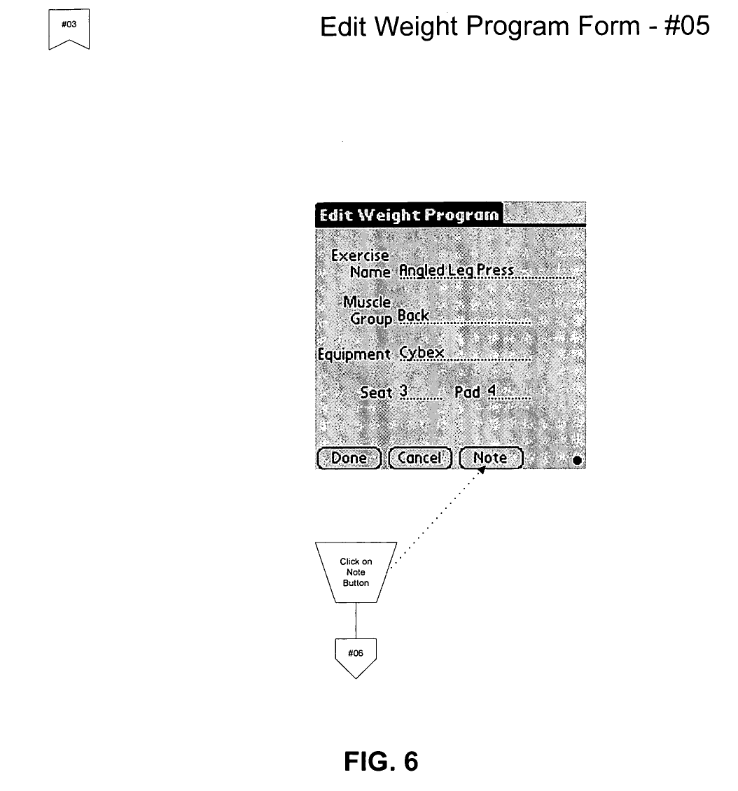

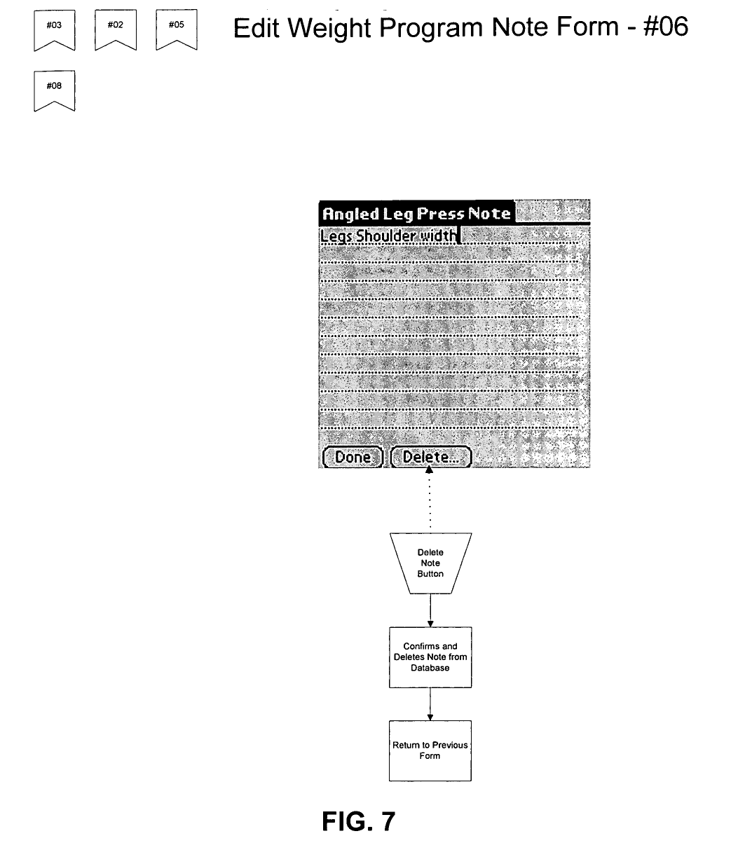

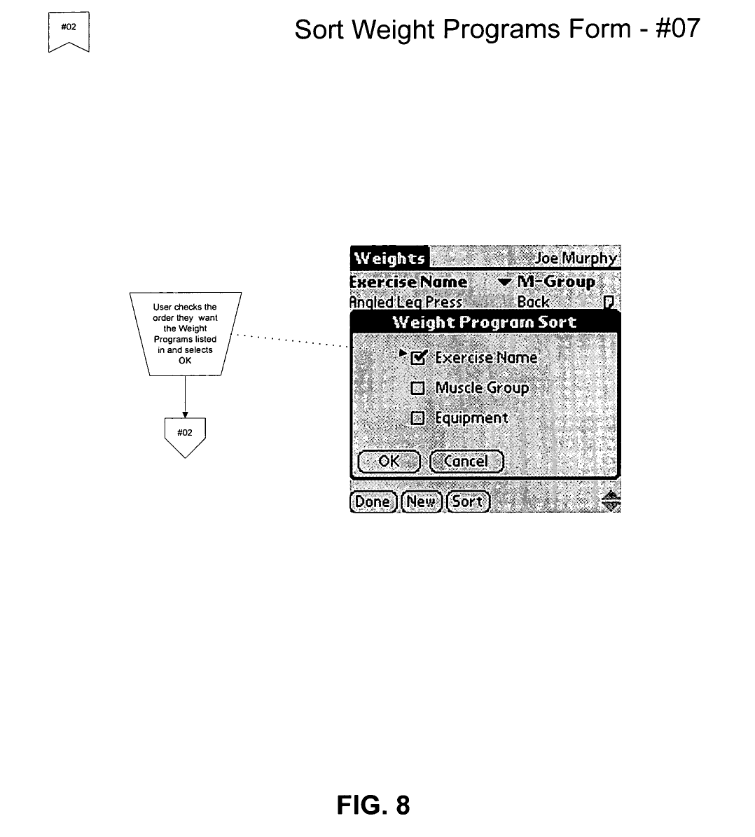

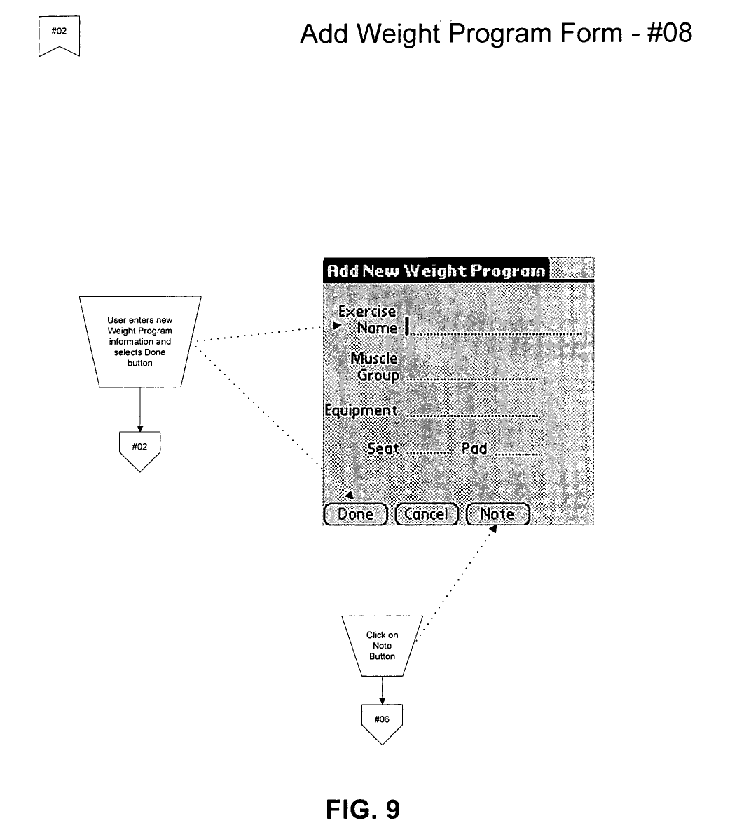

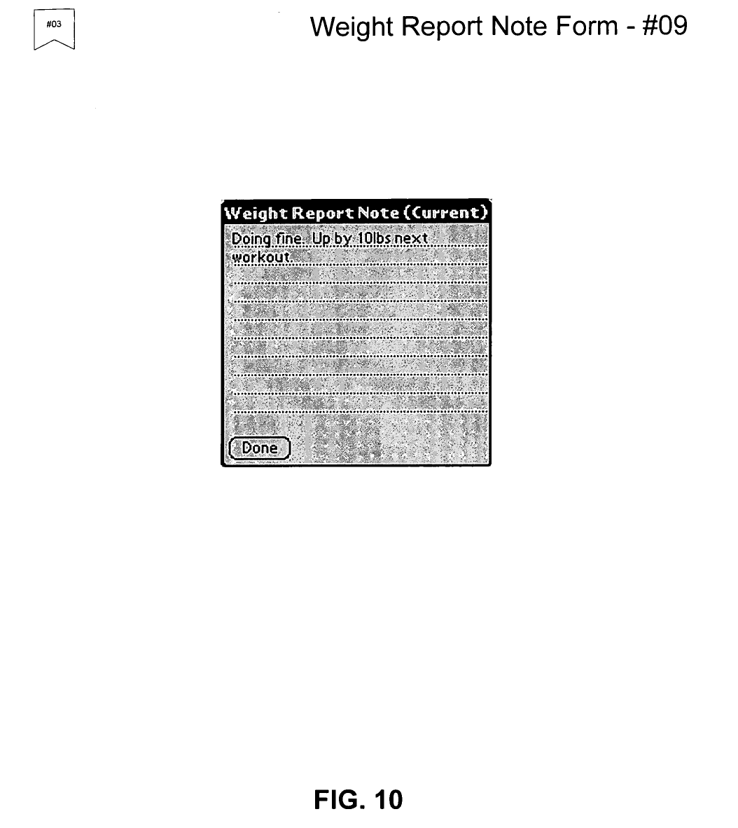

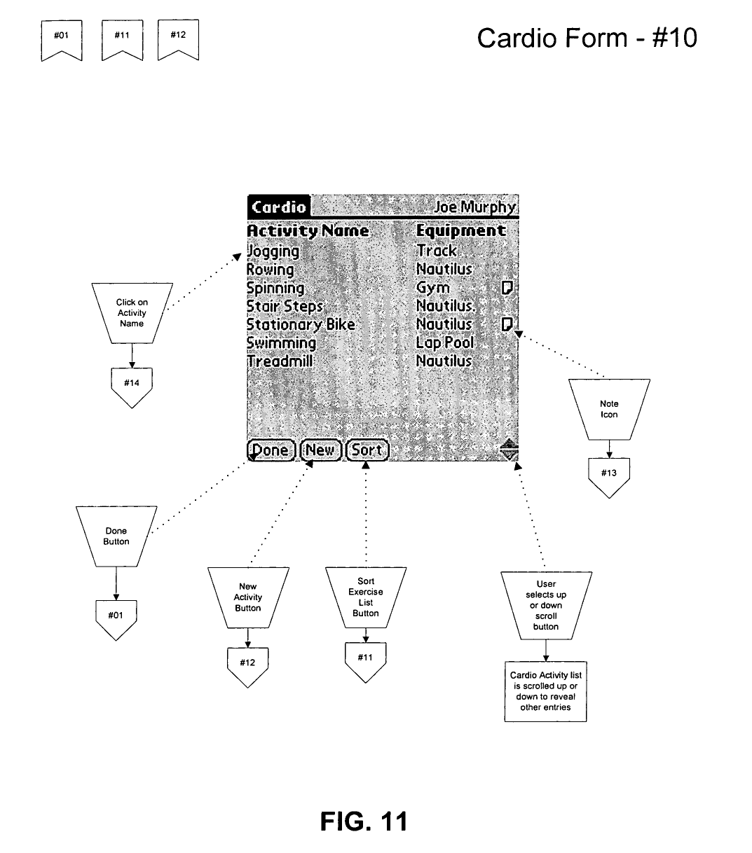

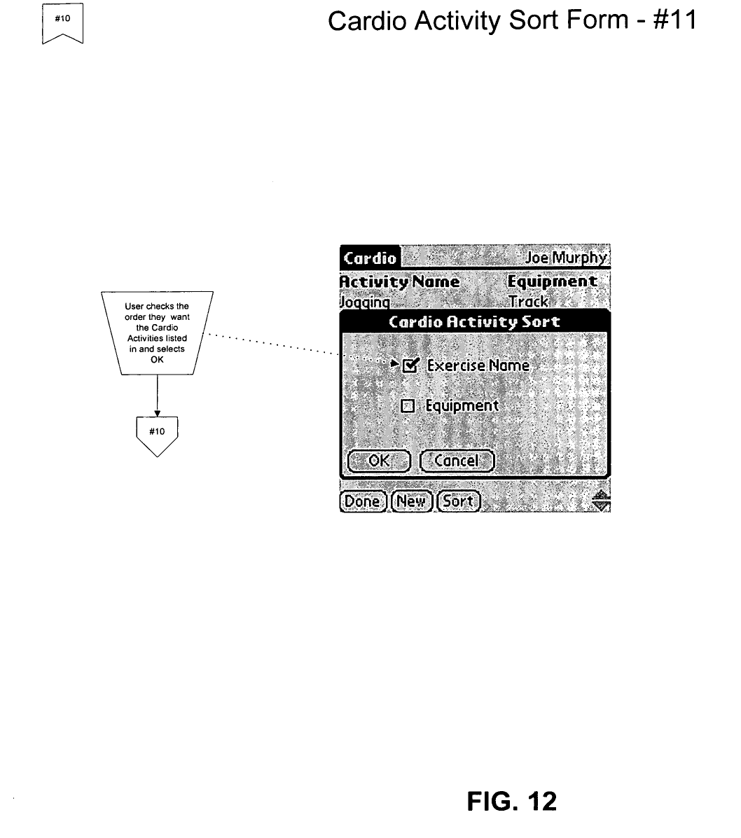

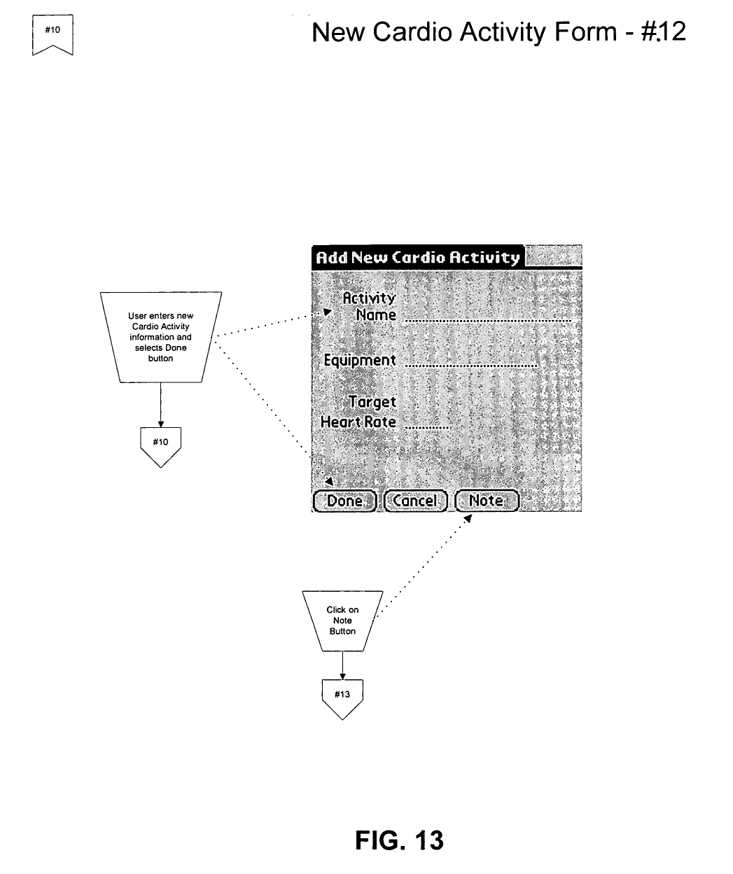

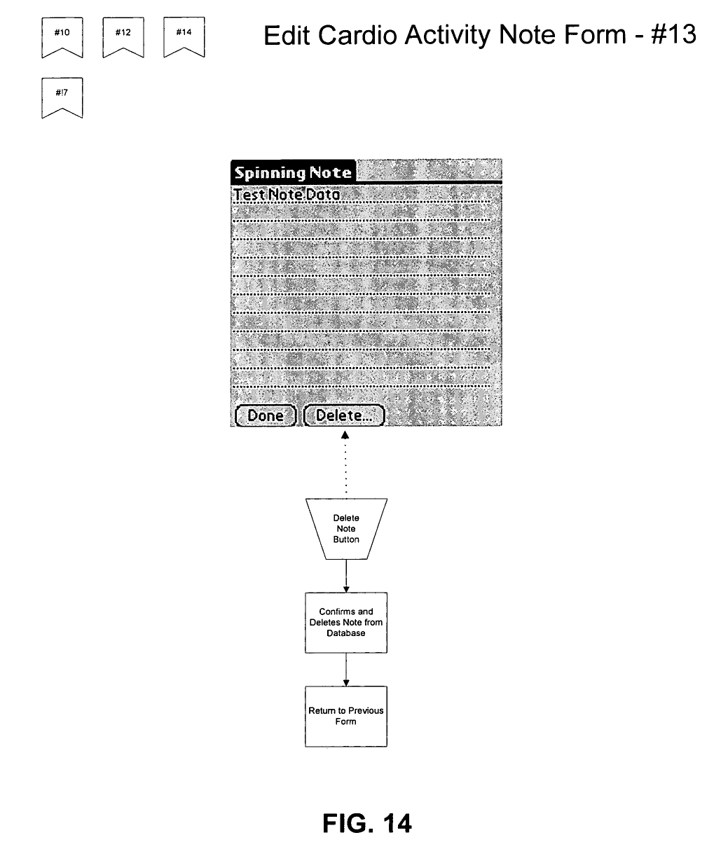

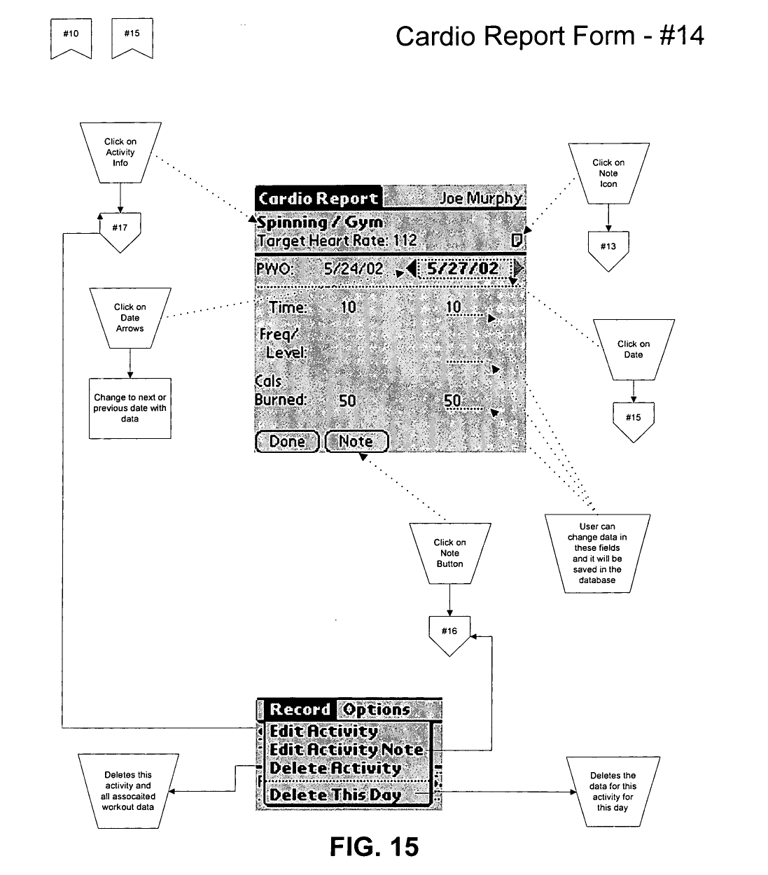

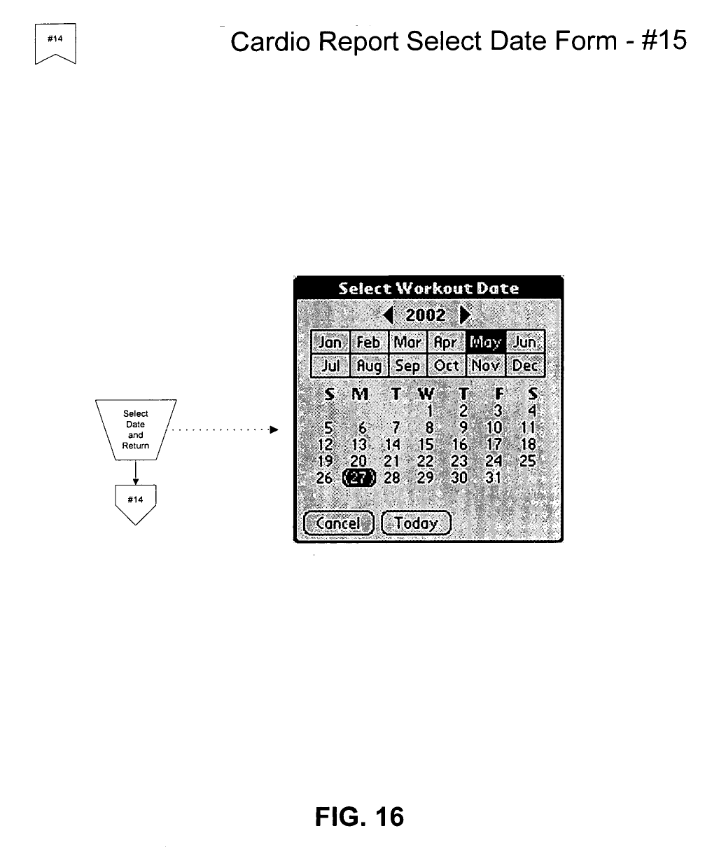

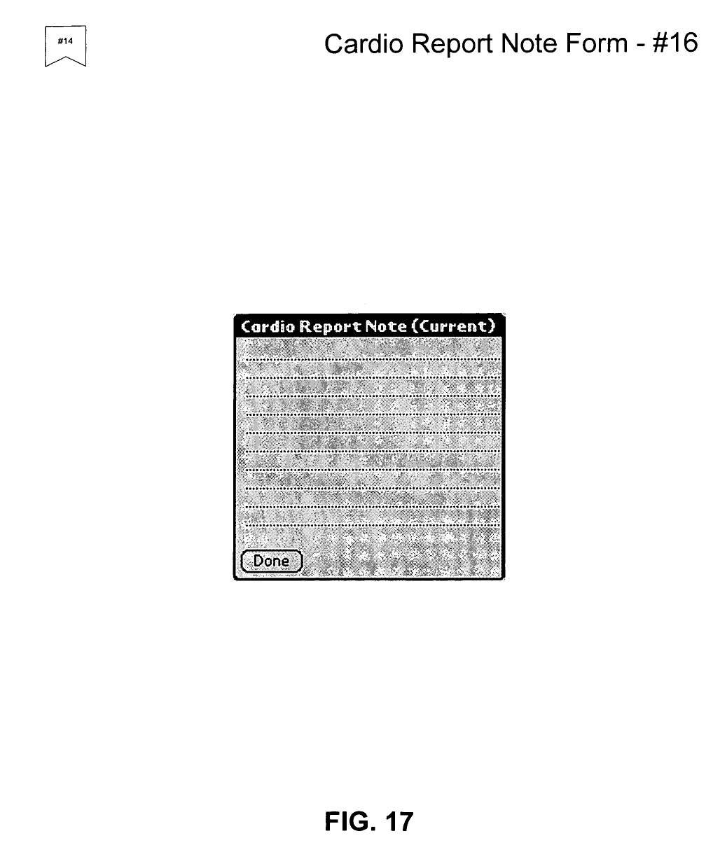

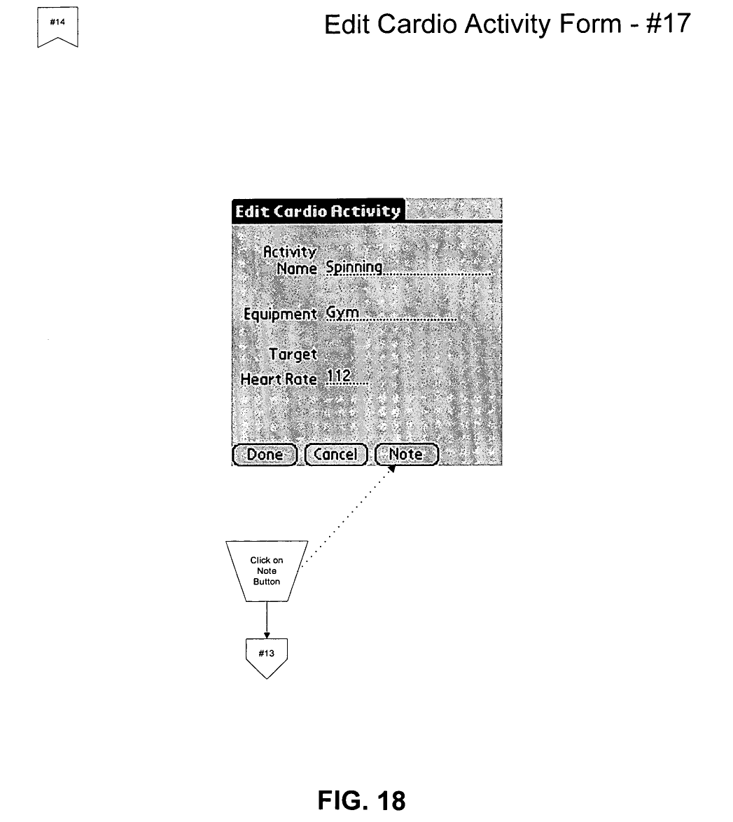

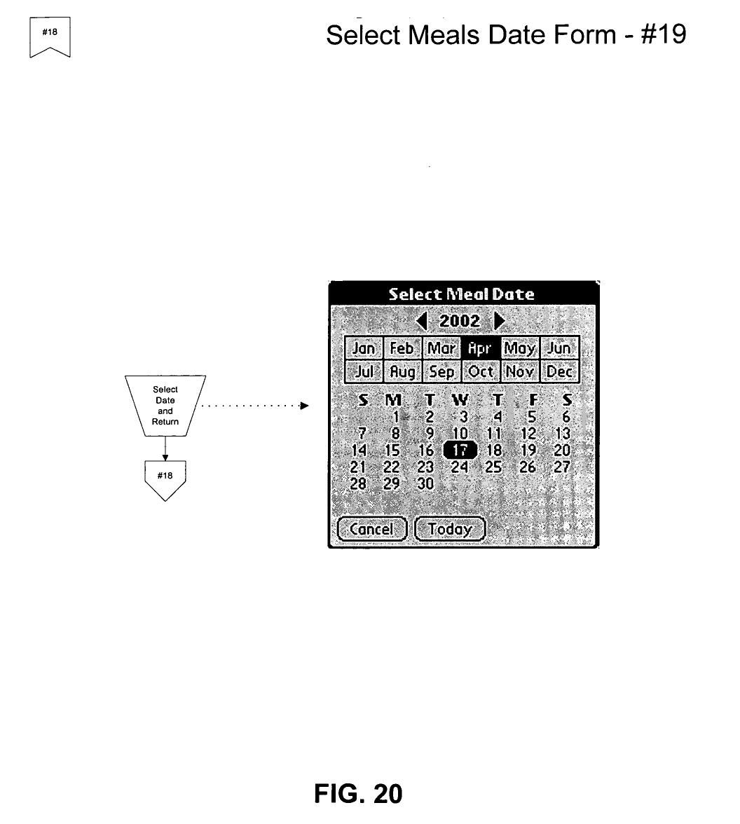

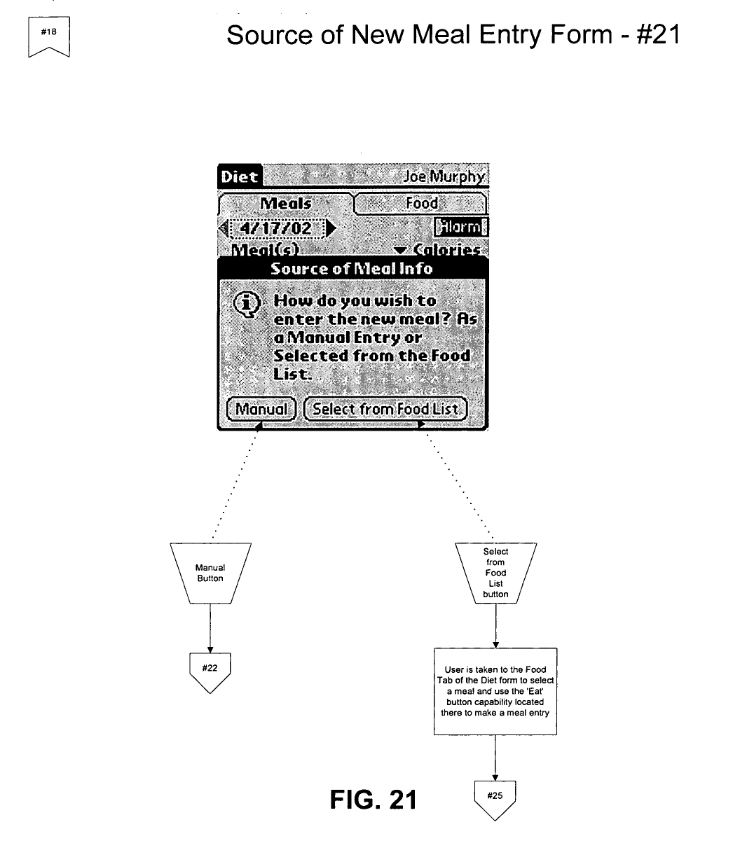

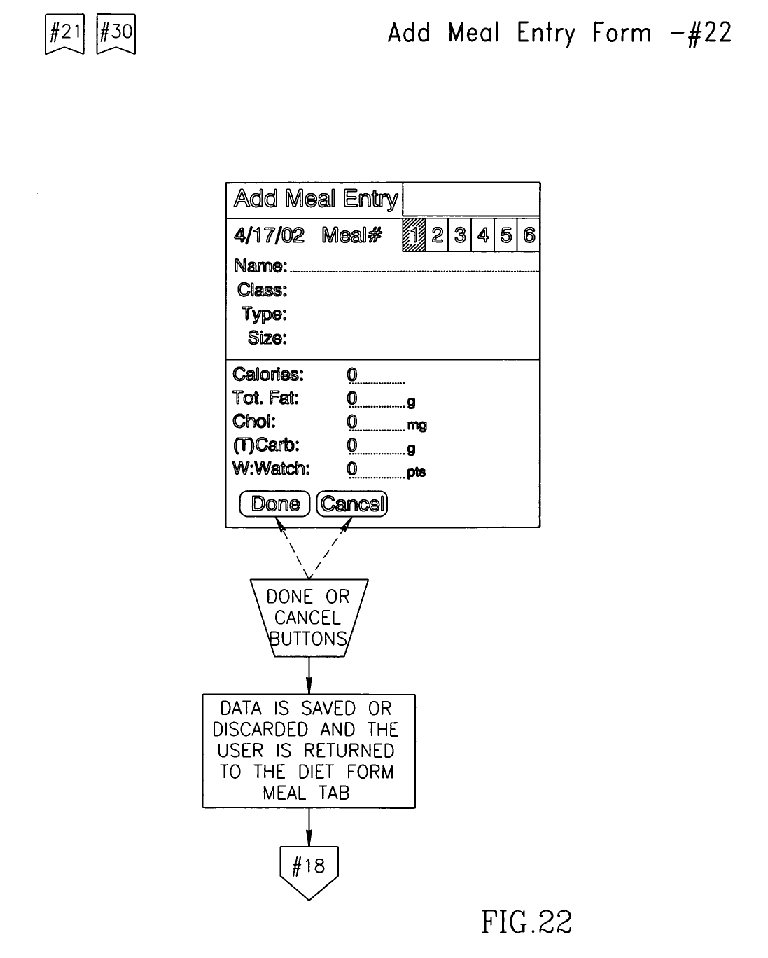

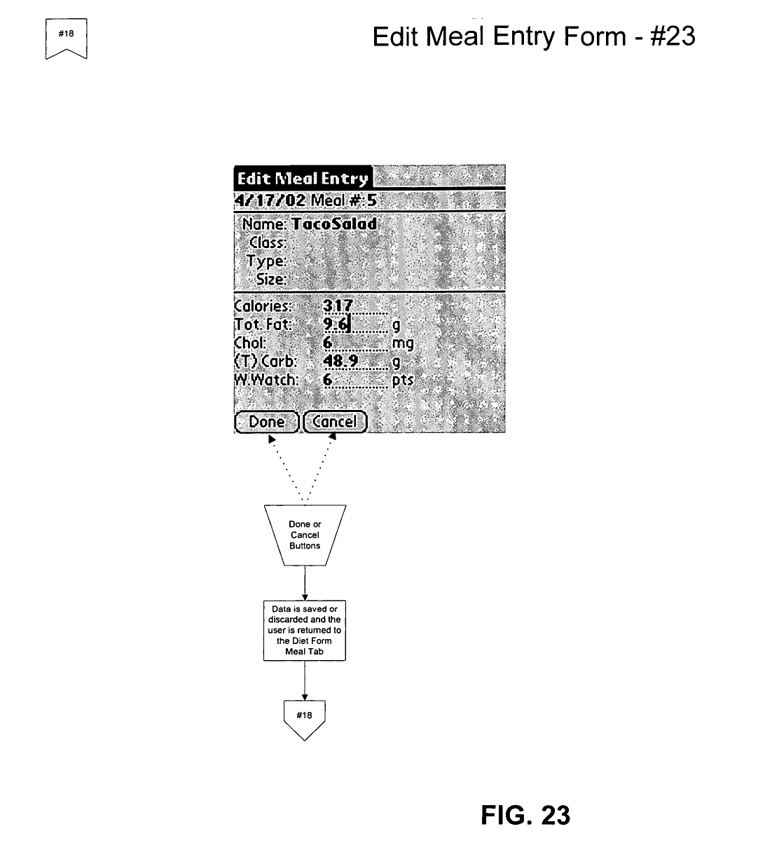

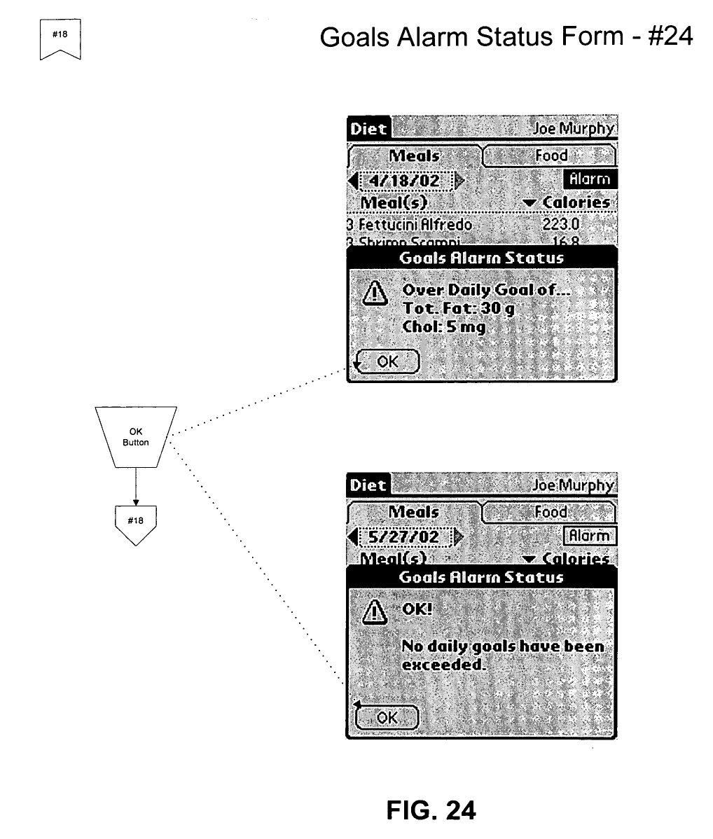

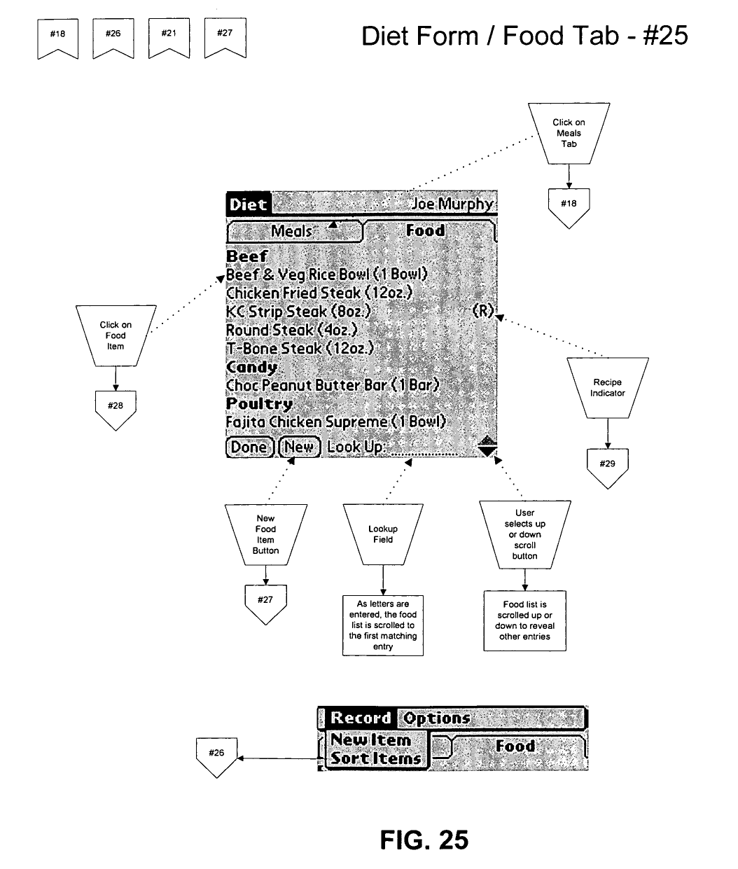

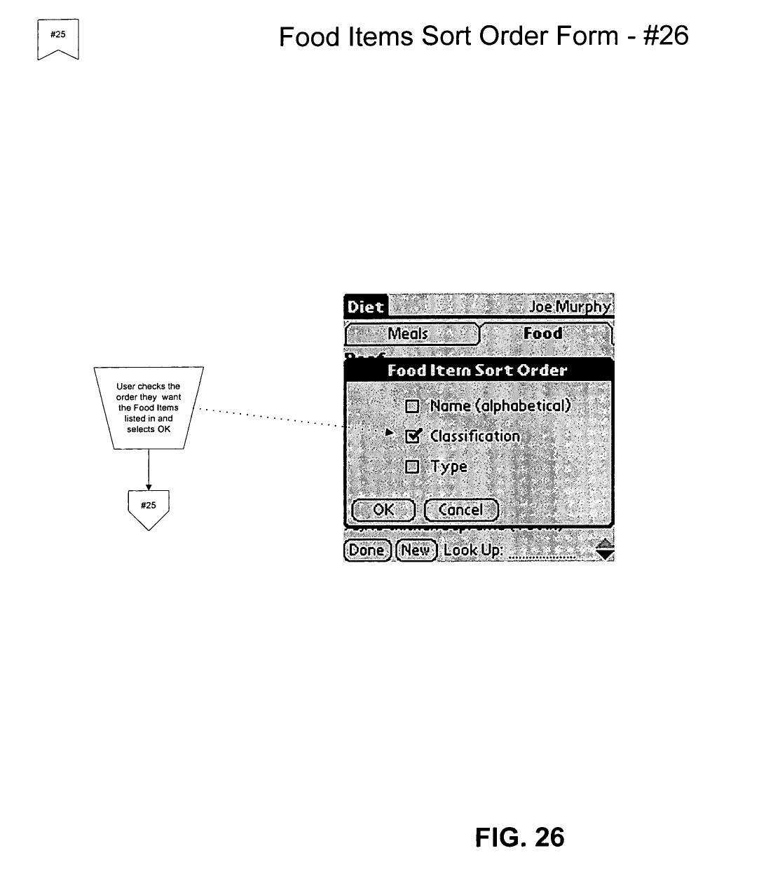

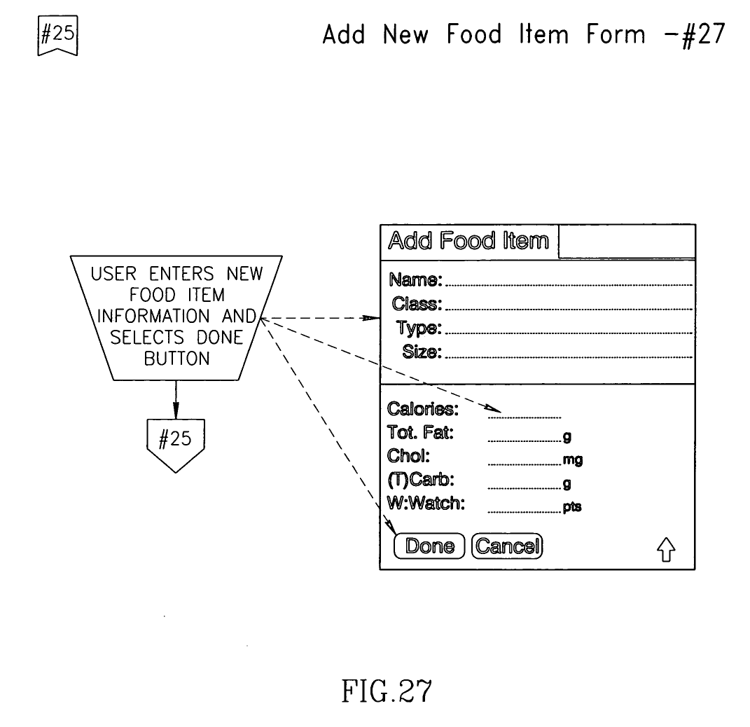

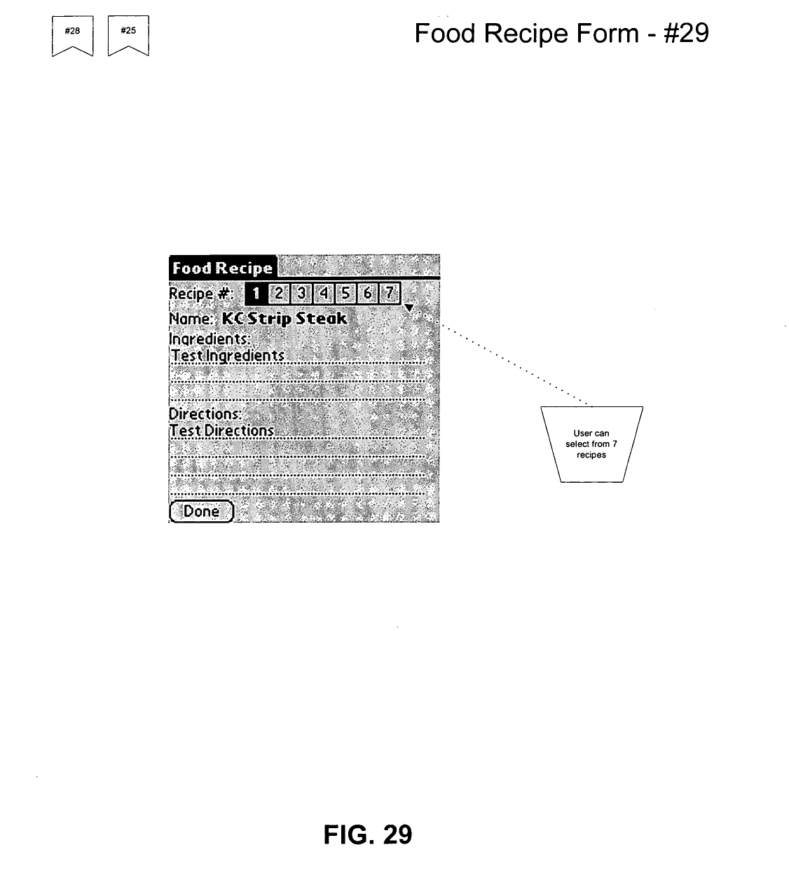

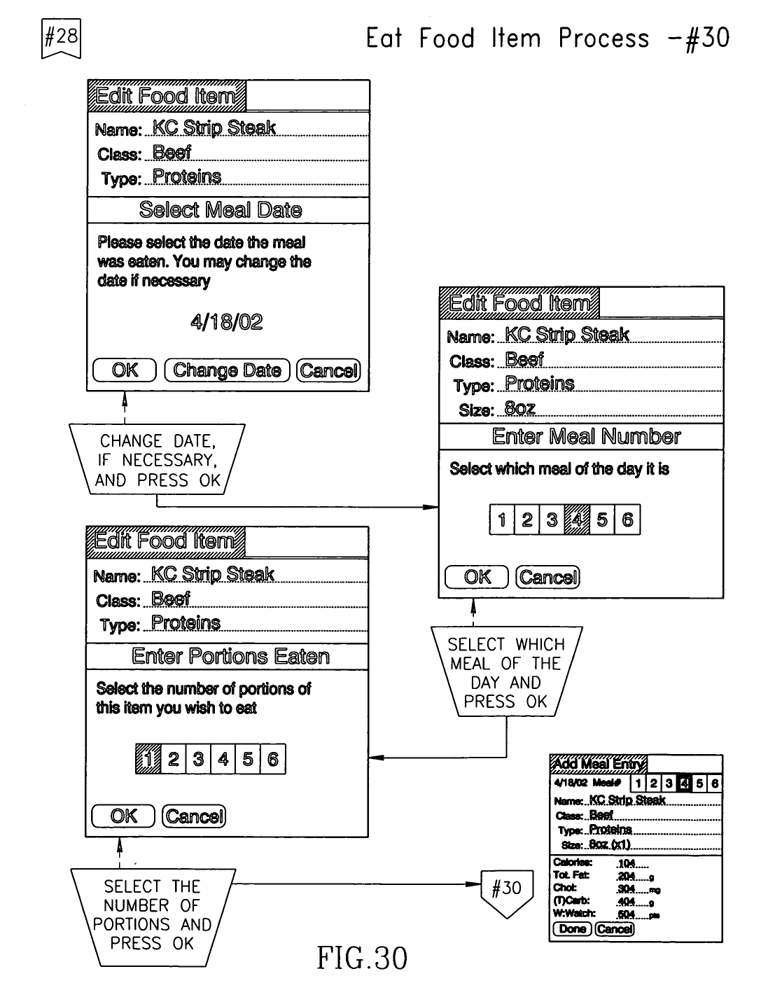

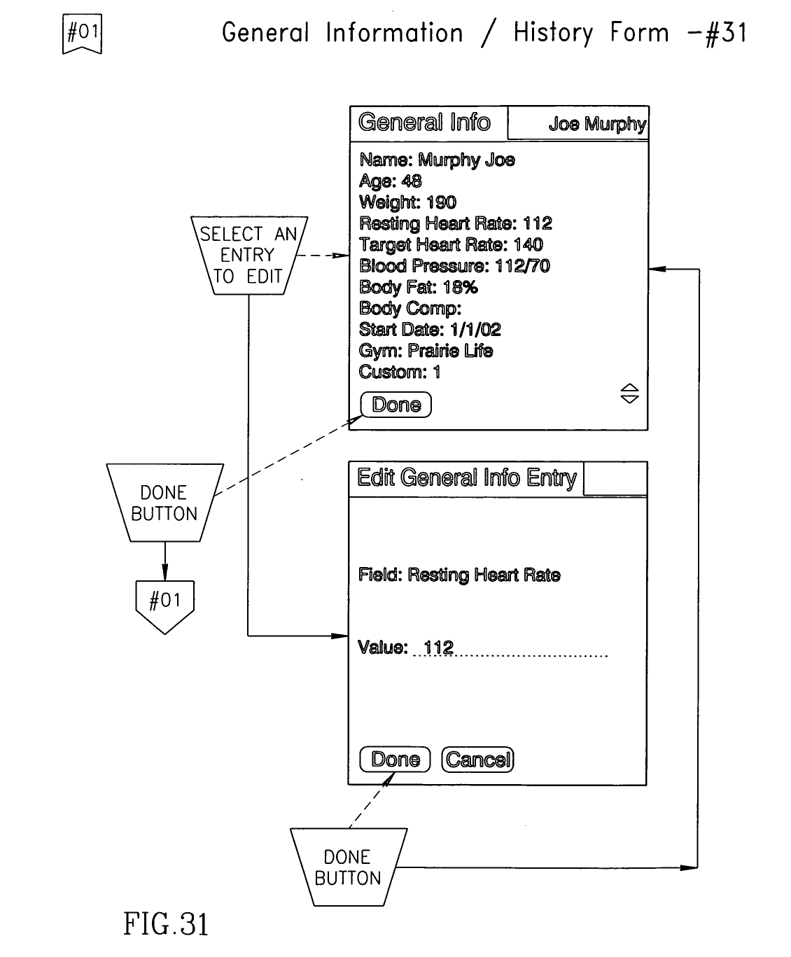

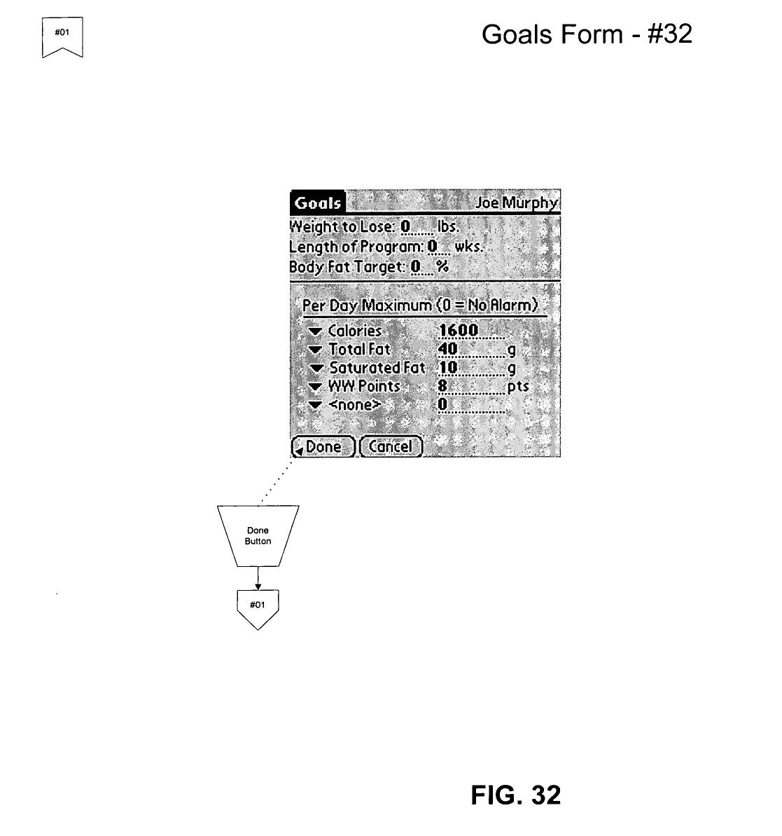

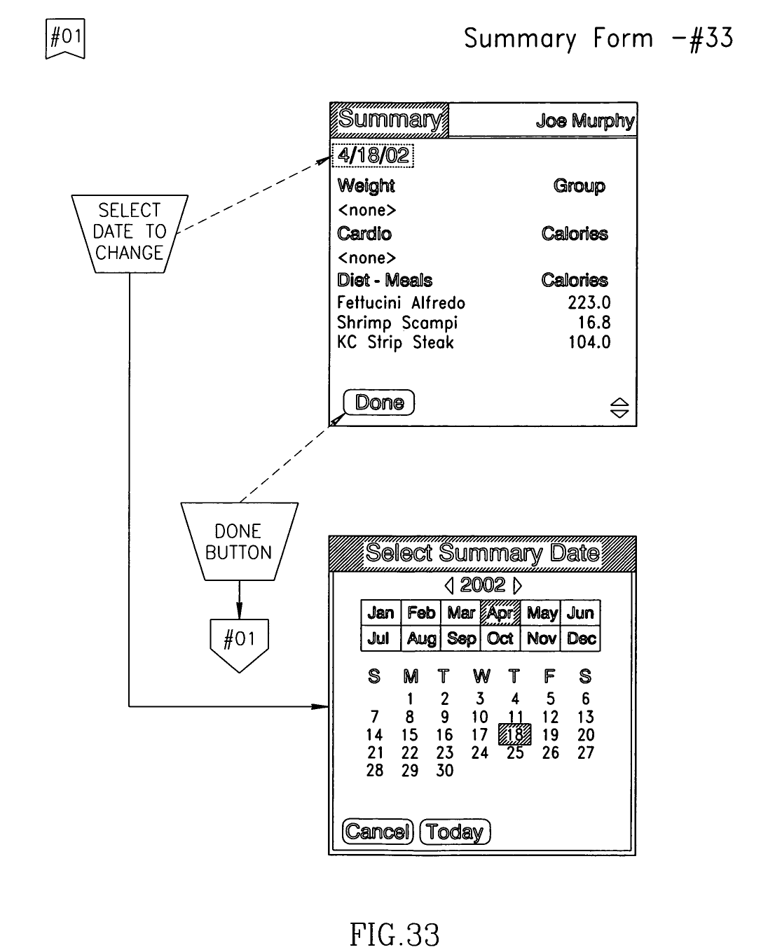

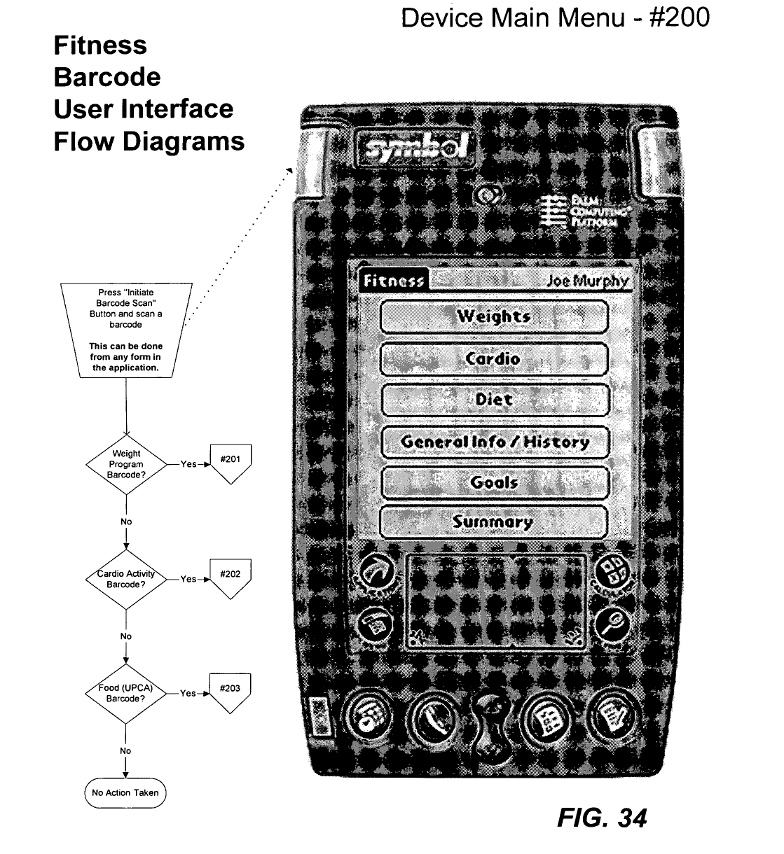

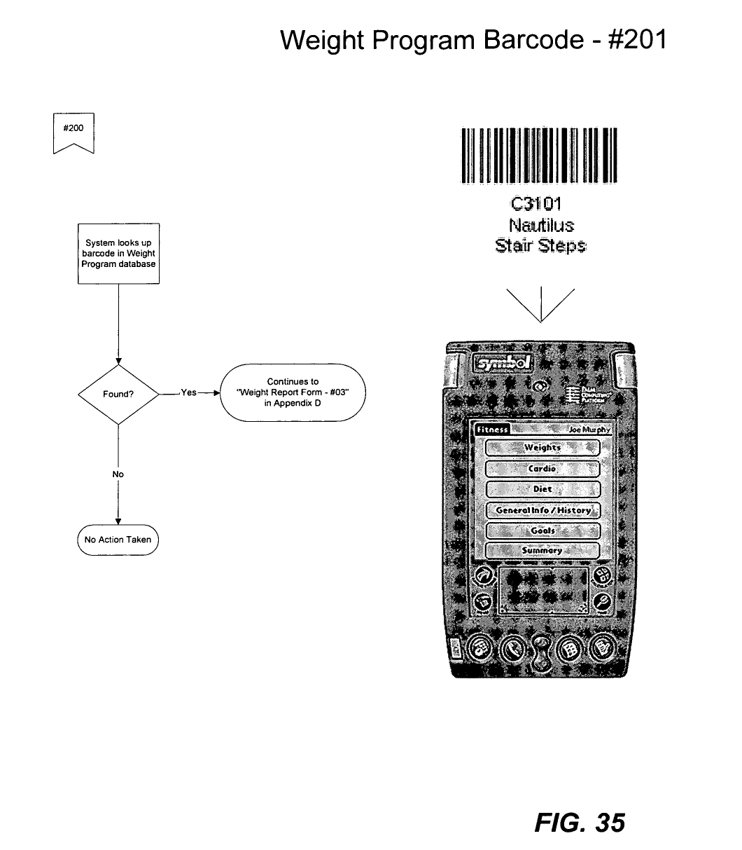

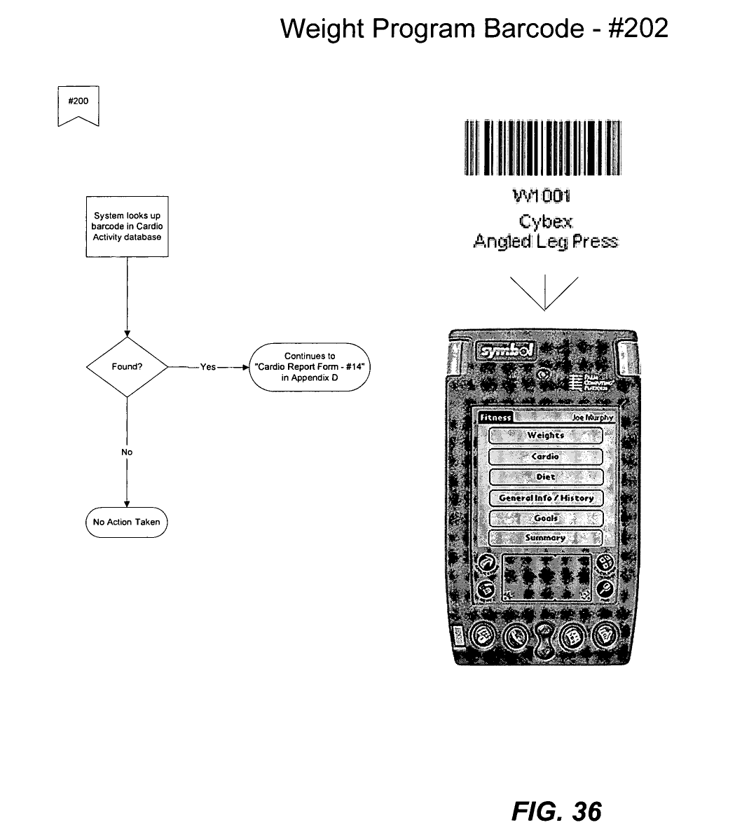

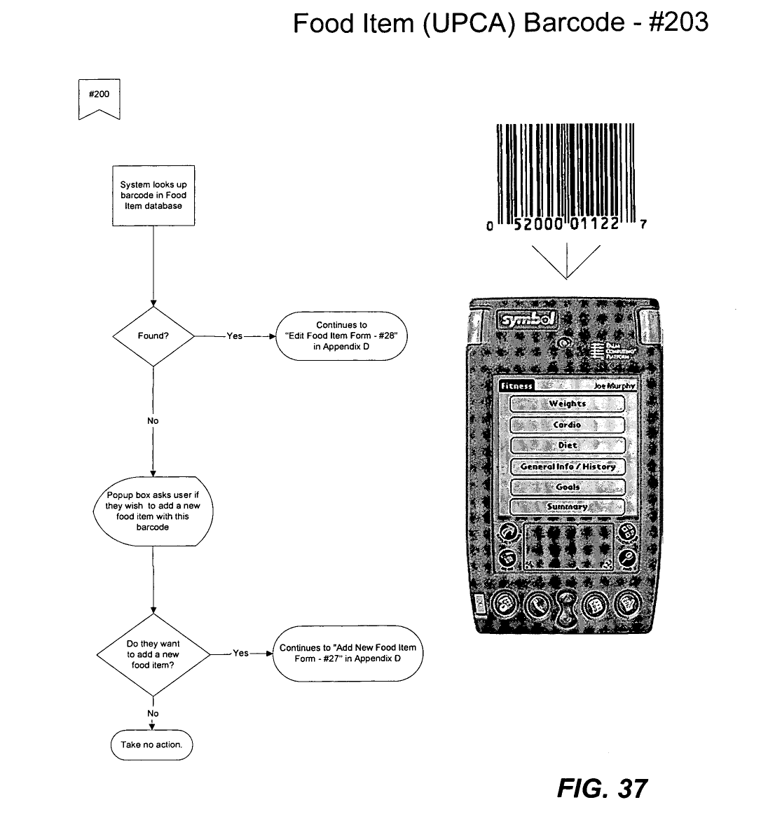

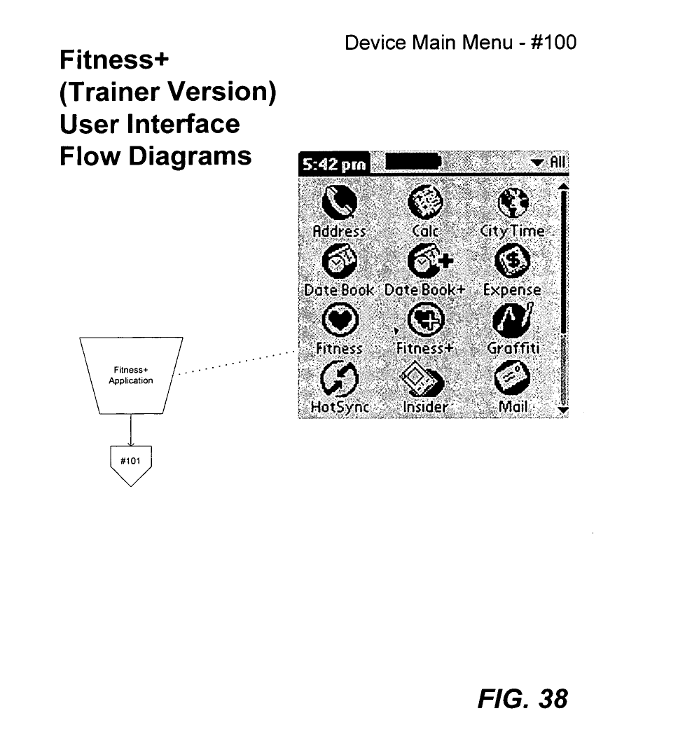

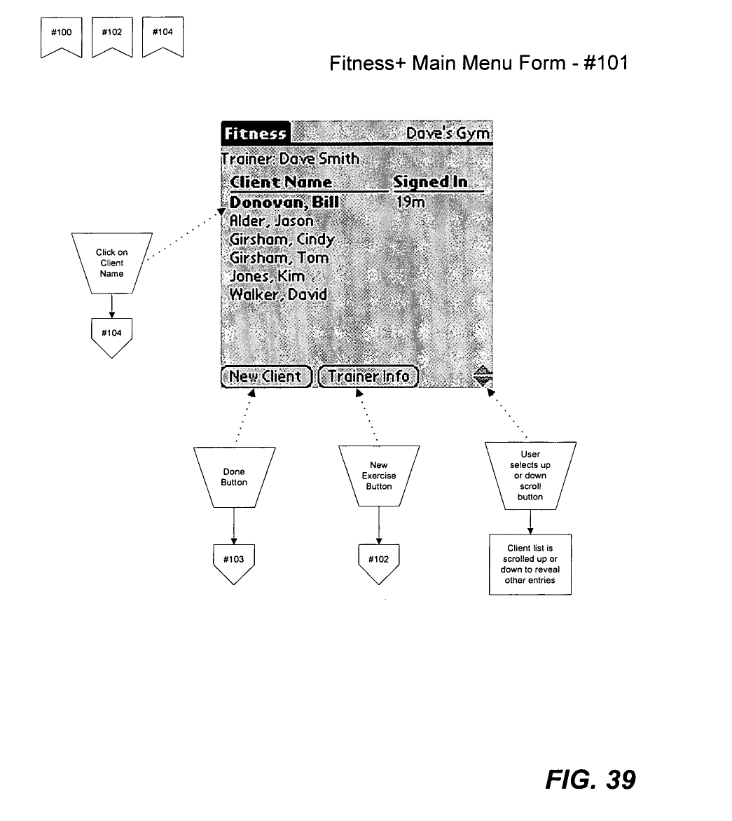

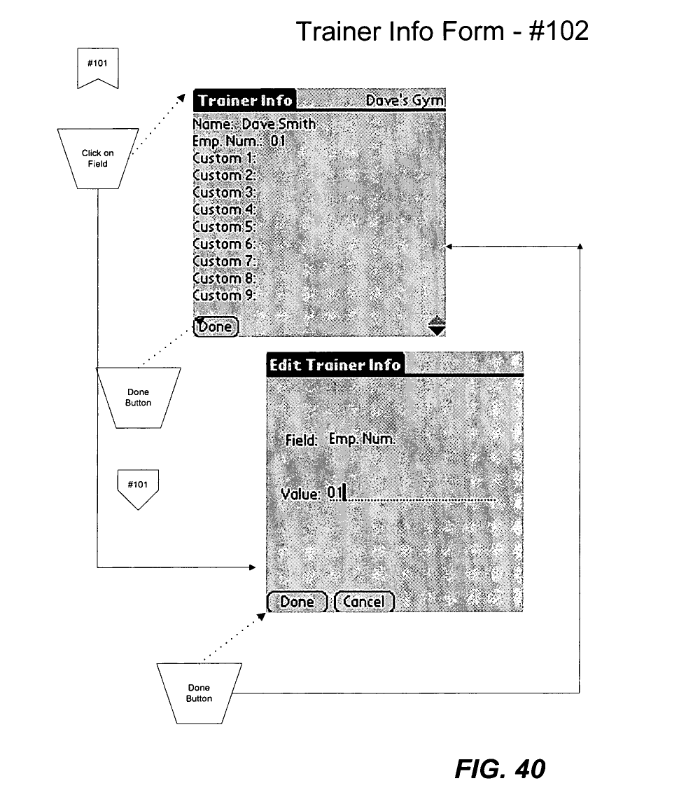

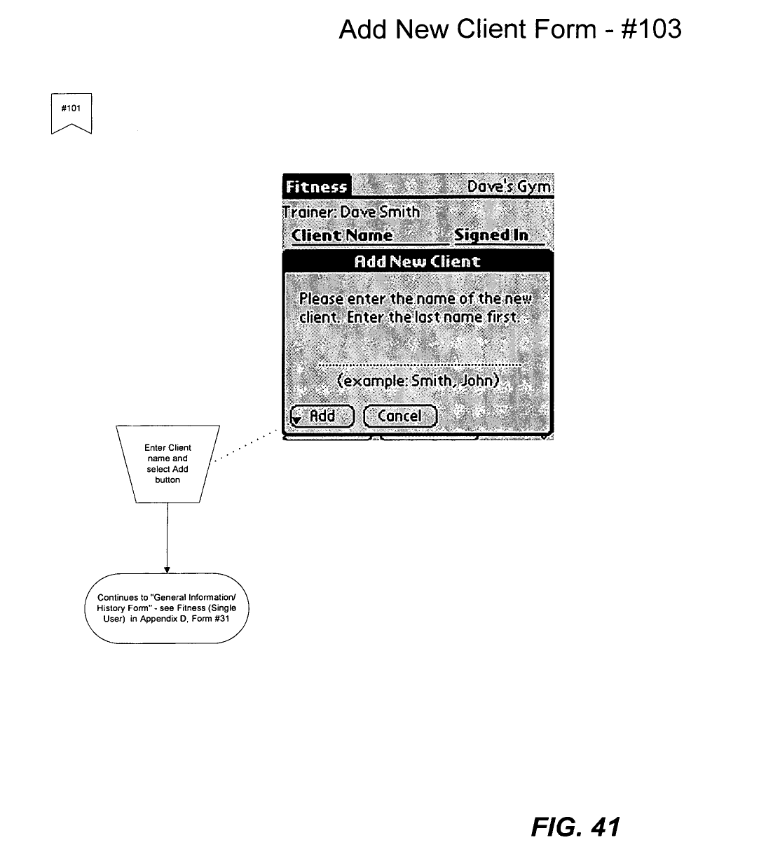

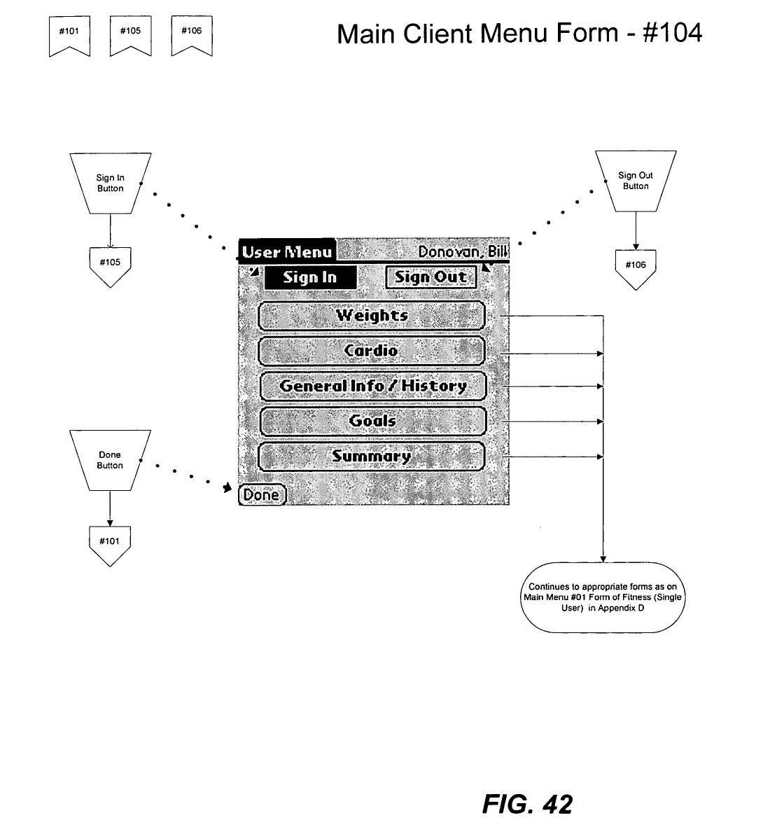

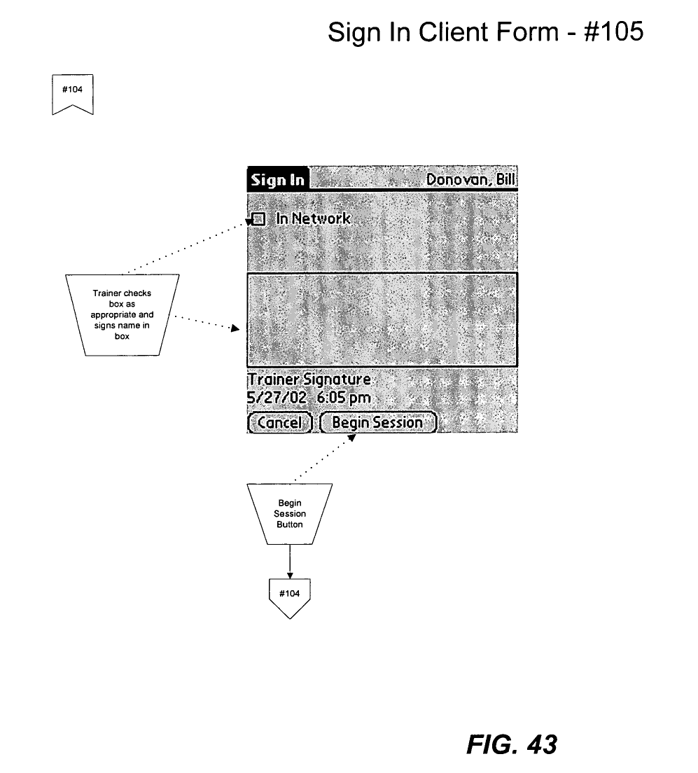

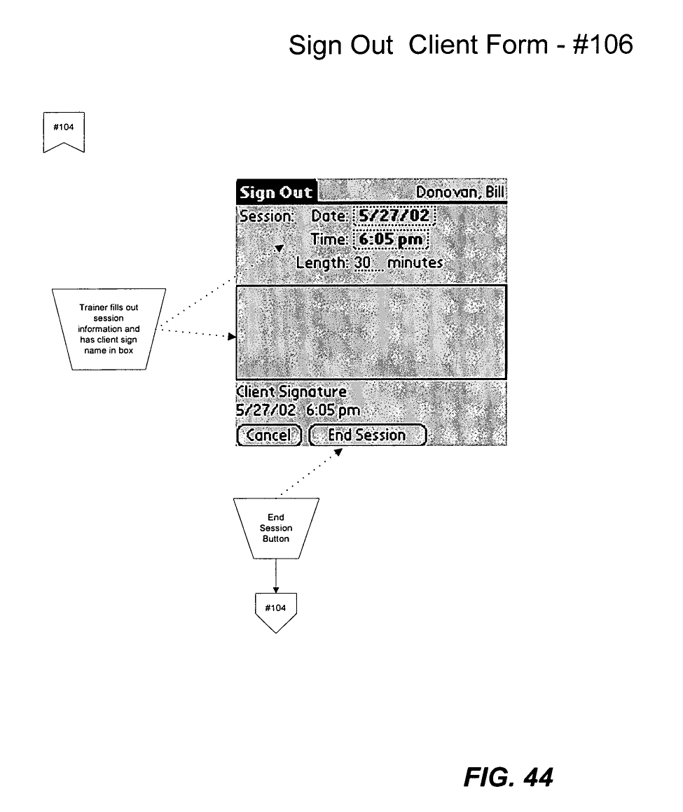

FIGS. 1-44 show exemplary screens that take a user through a variety of exercise and diet options. Additional screens are related to a trainer option. Other screens relate to barcode reading.

Turning to FIG. 45, there is shown a handheld device 100, in electronic communication or linked (by wired or wireless links) with a computer 102. The computer includes a compact disc (CD) 104 or other source of stored data (storage media). With the handheld device 100, now linked or “synched” up to the computer 102, data stored in the CD 104 can be downloaded into the handheld device 100. Additionally, programs, scripts and portions thereof can also be loaded into the handheld device 100 from the computer 102, and the handheld device 100 can also send data to the computer 100. Still further, other barcodes can be downloaded into the memory of the handheld device, by the user accessing the database or storage device, and selecting the desired bar codes and downloading them in accordance with conventional procedures.

Alternately, as shown in FIG. 46, the handheld device 100 may be linked or “synched” to a computer 102, as to perform all of the processes detailed in FIG. 45 and described immediately above. The only difference is that the computer 102 is linked to a network, such as the Internet 120. A home server (HS) 122 with a database or storage device with data corresponding to the bar code, all as detailed above, is accessible by the handheld device 100, that downloads the received or requested information (including programs, scripts, etc.) into its memory.

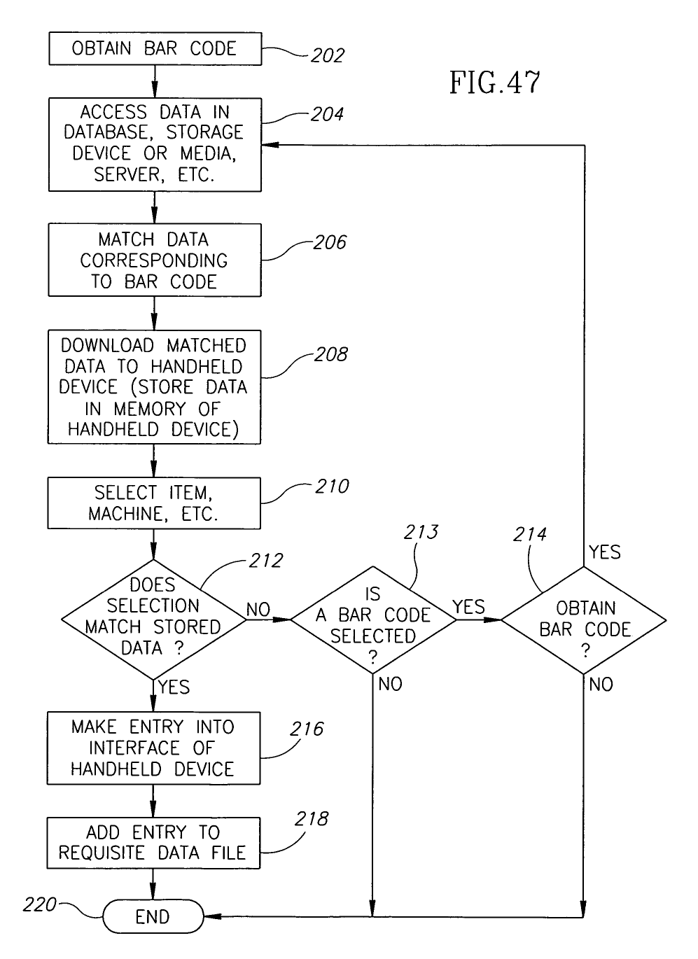

FIG. 47 is a flow diagram detailing a process in accordance with the invention. Initially at block 202, a bar code for an item (e.g., food item), machine (e.g., exercise machine) or the like is obtained by the handheld device. The handheld device is then connected to a database or storage device, typically as shown and described for FIGS. 45 and 46, at block 204. Within the computer 100, server 122 or the like, the bar code is matched to the stored bar code, at block 206. The data corresponding to the barcode, as stored in the database, storage device, etc., is then downloaded into the memory of the handheld device, at block 208. In the case where the user desires to select a barcode and download it into his handheld device, before scanning barcodes, the process would start at block 204.

At block 210, the desired item, machine, etc. would be selected, either manually by touching a menu on the handheld device or as a barcode on the item or machine, that is scanned into the handheld device. The handheld device would execute a program, matching the scanned barcode with the stored barcode and data associated therewith, at block 212. If there was a not a match, it is then determined if selection involves scanning a bar code, at block 213. If a bar code is not being selected, the process moves to block 220, where it ends. If a bar code is being selected, the user decides if they want to obtain this bar code (as detailed for block 202), at block 214. If they do not want to obtain this bar code, the process moves to block 220, where it ends. If they want to obtain this bar code, it is entered into the memory of the handheld device, and the process moves to block 204.

If there is a match at block 212, a screen or interface for the item or machine appears on the handheld device at block, and action as to this item, machine, etc, can be noted or entered on the screen, at block 216. The item is then eaten or the machine is used, and noted on the handheld device by contacting it, for example, the “EAT” button of FIG. 28b and the “NOTE” button of FIG. 4. The item eaten or machine utilized will then be noted on the handheld device and logged into it and recorded in the requisite data file, at block 218. The process moves to its end at block 220. The process can be repeated for as long as desired.

The weight lifting user interface allows for the entry of desired weight lifting goals, and for the user to retrieve those goals during a workout, so as to ensure uniformity in the user's workout. The user can retrieve information related to which exercises apply to particular muscle groups and which equipment will be used. The user also can select from exercise names, which relate to specific types of exercises directed towards specific muscle groups. The exercise name user interface will include how many sets and reps the user is to do as part of his or her weight lifting program. Included with this information will be the amount or poundage of weight to be lifted. Information is further provided related to the type of machine to be used and the setting of the machine.

A function is provided for setting dates related to the user workouts. The user interface option is further provided so that information can be changed on the interface to reflect a change in the user's workout. A note function is also provided which allows for notes related to the exercise or workout to be recorded and retrieved at a later time.

A function is provided for cardiovascular exercises related to the user workouts. The user interface option is further provided so that information can be changed on the interface to reflect a change in the user's workout. A note function is also provided which allows for notes related to the exercise or workout to be recorded and retrieved at a later time.

The cardiovascular user interface allows for the entry of desired cardiovascular goals, and for the user to retrieve those goals during a workout, so as to ensure uniformity in the user's workout. The user can retrieve information related to particular cardiovascular exercises and which equipment will be used. The information can relate to a treadmill, stationery bike, rowing machine, etc. The user also can select from exercise names, which relate to specific types of exercises directed towards specific cardiovascular exercises. The exercise name user interface will include time and target heart rate the user is to accomplish as part of his or her cardiovascular program. Information is further provided related to the type of machine to be used and the setting of the machine.

A function is provided for diet related to the user food consumption and food selection. The user interface option is further provided so that information can be changed on the interface to reflect a change in the user's diet or food selection. A note function is also provided which allows for notes related to a particular food. Information related to menu and calories and other nutritional information in a food item can be retrieved.

The diet user interface allows for the entry of desired daily caloric and nutritional goals, and for the user to retrieve menu options to help achieve these goals. An alarm function is included for alerting the user of surpassing set caloric and nutritional goals. The user can retrieve information related to planning menus and information on singular foods. A notation function is included to allow for recording of dietary notes.

An additional option includes placing a barcode reader on the graphical user interface device, wherein the barcode reader can be used to review barcode information and retrieve that information for the user. The barcode is used to add non-inventory data and general or customized data. In particular, the barcode reader can be used to track a user's diet and exercise information by reading the barcodes off of food packages or exercise equipment. This will allow for retrieval of calorie and nutritional information. The barcode reader can also be used to scan marked exercise equipment, wherein the barcode will be read with the user interface device, and a report on the user interface will be generated. The report will tell the user how many reps were previously performed on the device related to a particular exercise at a particular weight and allows entry of new workout information.

If the database does not include information related to a barcode, a barcode can be read and stored, and the user can enter non-inventory information to associate with the barcode for future use and retrieval. Thus, a function for adding new information is included. This can be used with any of a variety of applications.

Related to the barcode reader, the teachings of the invention contemplate a genus of interfaces for portable laser-scanning, charge coupled device, and wand type barcode scanning engines, magnetic stripe and magnetic ink readers, keyboards or 10-key keypads, optical character recognition devices, and trackballs using PCMCI, springboard modules, serial cables or infracted (IR) to interface these devices with host PDAs or palmtop computers.

The advantages of implementing interfaces for frequently used input devices on industry standard modules, cables or IR are plentiful. First and foremost is the fact that such an “open system” combination gives the user the advantage of not being locked into a proprietary technology that can become obsolete in a matter of months in the fast moving world of high tech electronics. What this means to a user is that when a better PDA or palmtop computer comes out, the user does not have to buy all new input devices designed specifically to work only with that computer, as long as the new computer has an industry standard PC card or module slot or serial interface or IR. Thus, if the manufacturer of the new computer does not offer a proprietary CCD or laser-based barcode scanner, the user is not precluded from using such an input device, as long as the new computer-has a PC card or module slot or serial interface or IR. Likewise, when a new input device with better features appears on the market, the user is not precluded from switching to the new input device for use with his or her existing PDA, as long as he or she has a PC card implementing an appropriate interface for the new signals.

An optional embodiment of the interface is for a laser type barcode scanning engine, the PCMCIA-defined PC card or module or serial interface or IR has attached thereto a housing, which contains a visible light laser diode, scanning optics, and a photodetector. The scanning optics scan a laser beam across a barcode and detect reflected light. In some embodiments, the PCMIA-defined PC card or module or serial interface or IR has circuitry integrated thereon to sample the analog signal from the photodetector and create a digital image thereof in memory, and decode the digital image in memory into an ASCII or EBCDIC character string representing the alphanumeric text encoded into the barcode. (ASCII or EBCDIC are industry standard codes that define for each alphanumeric character a unique string of l's and O's that are a binary code for that character.) In addition, there is circuitry integrated on the PCMCIA defined PC card to send the decoded data from the photodetector to the host PDA for use by an application program in execution thereon.

Finally, the present invention can be used by fitness industry professionals to assist customers with a workout or diet program. Data for a client can be entered and later retrieved to help clients achieve fitness goals. Additionally, interaction can be used for billing and payroll functions. In particular, client sessions can be entered and validation with signatures.

### EXAMPLES

Examples 1 and 2 illustrate processes in accordance with the present invention and can be in accordance with the flow diagram of FIG. 47, but are not limited thereto.

### Example 1

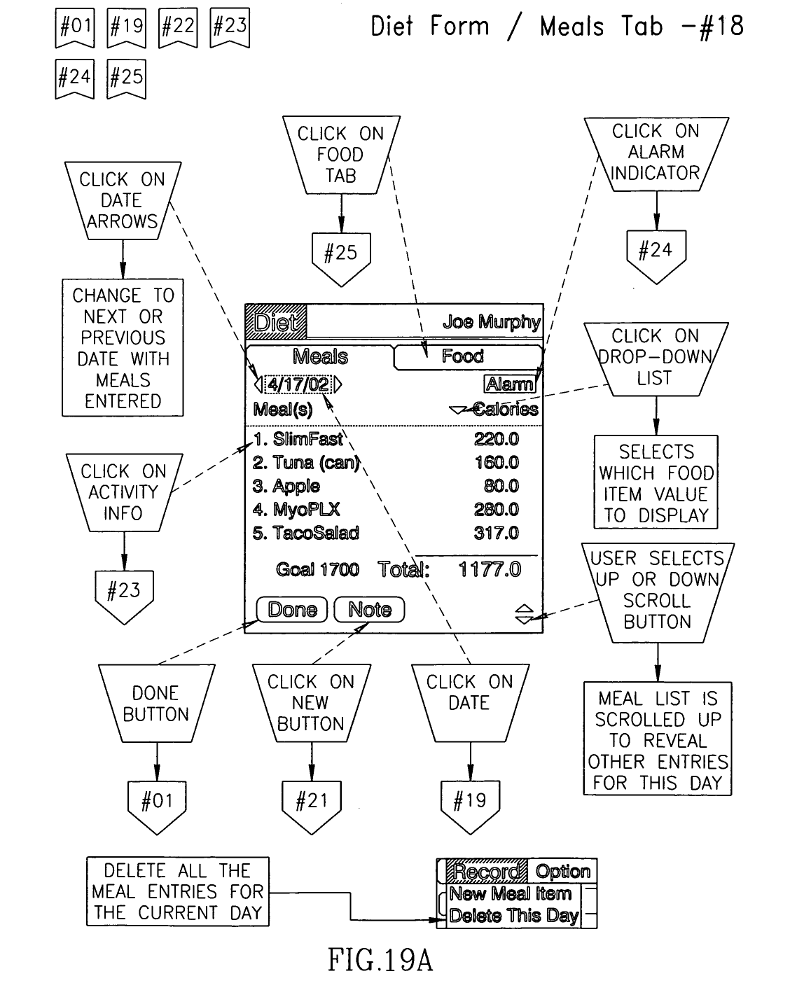

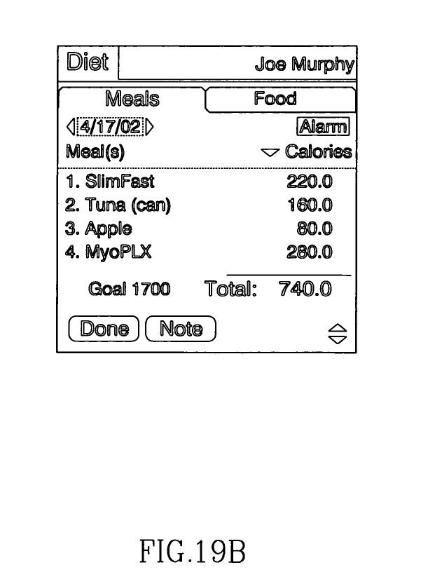

A Myoplex® bar (a food item) may be on a store shelf The bar code reader of the handheld device will read the bar code of the Myoplex® bar and store it in the memory of the handheld device. The handheld device will then be linked or “synched” to the computer, as shown in either of FIG. 45 or 46, where the bar code will be sent to the computer and ultimately matched with a corresponding bar code in the database, storage device, storage media, etc. Information, on the Myoplex® bar (MyoPLX), such as that detailed in FIG. 28b will then be downloaded to the handheld device and stored in its memory. When the Myoplex® bar is eaten, the user need only manually call it up, or scan its barcode. This will automatically cause the appropriate screen (or GUI) to appear on the handheld device, here, the screen of FIG. 28b. The user will then contact the “EAT” button. This contact of the “EAT” button will then add the Myoplex® bar to the user's meals for the day, in FIG. 19b, so he can monitor his food intake.

### Example 2

Turning to FIG. 4, a bar code can be downloaded by a user into his handheld device, for a Cybex® Angled Leg Press Machine, with places for a workout chart. This downloading is in accordance with FIG. 45 or 46 and described above. The user can manually enter his set workout (this set workout can also be preprogrammed, it need only be downloaded). The user will now go to that machine in the workout facility, scan the bar code, and the screen (GUI) of FIG. 4 will automatically appear on the handheld device. The user then manually enters his actual workout for a particular date. The data is complete, when the user contacts the “DONE” button.

The above described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

1. A method for recording and storing custom and dietary fitness information on a graphical user interface device, equipped with a barcode reader to expedite the user's entry of custom and general information:
a) providing an interactive graphical display, which includes fitness categories, which are interactively selectable by a user on the graphical display surface, wherein fitness categories that are selectable include weights, cardiovascular, diet, history, goals, and summary, generated barcodes can be scanned so that information related thereto may be added; and,
b) selecting a category and entering or retrieving fitness data.

2. A system for tracking fitness, wherein said system comprises:
a graphical user interface device;
a bar code reader for electronically coupling with the graphical user interface device; and
the graphical user interface device including a processor programmed to:
receive data corresponding to at least one bar code as read by the bar code reader; and
provide data corresponding to a graphical user interface for display on the graphical user interface device for monitoring at least one of diet, exercise or weight training, in accordance with the at least one bar code read by the bar code reader.

3. The system of claim 2, wherein the data corresponding to the graphical user interface includes non-inventory data.

4. The system of claim 2, wherein the bar code reader is attachable to the graphical user interface device.

5. The system of claim 2, wherein the bar code reader is incorporated into the graphical user interface device.

6. A method for monitoring fitness and diet information comprising:
obtaining data associated with one of an item or an apparatus;
selecting at least one item or apparatus by scanning a bar code associated therewith;
providing a graphical user interface corresponding to the at least one item or apparatus;
receiving input provided to the graphical user interface; and
adding the input to at least one data file for either of the fitness or the diet information.

7. The method of claim 6, wherein the obtaining data includes accessing data in a database corresponding to at least one an item or an apparatus.

8. The method of claim 7, wherein the obtaining data includes obtaining a barcode for at least one item or an apparatus.

9. The method of claim 6, wherein the obtaining data associated with one of an item or an apparatus includes accessing at least one source of non-inventory data associated with the item or the apparatus.

10. The method of claim 9, wherein the at least one source of non-inventory data includes a database.

11. The method of claim 9, wherein the at least one source of non-inventory data includes a server.

12. The method of claim 9, wherein the at least one source of non-inventory data includes a storage device.
